(19) United States
(12) Patent Application Publication
(10) Pub. No.: US 2018/0355290 A1
(43) Pub. Date: Dec. 13, 2018

(54) NON-HOMOGENEOUS COMPOSITIONS

(71) Applicant: The Procter & Gamble Company, Cincinnati, OH (US)

(72) Inventors: Scott William CAPECI, NORTH BEND, OH (US); Chong GU, Beijing (CN); Justin Thomas CACCIATORE, Cincinnati, OH (US); Sebastian VARGAS, Cincinnati, OH (US); Hongling CHEN, Beijing (CN); Xu HUANG, Beijing (CN); Qi ZHANG, Beijing (CN); Hanjiang ZHU, Beijing (CN)

(21) Appl. No.: 16/001,979

(22) Filed: Jun. 7, 2018

Related U.S. Application Data
(60) Provisional application No. 62/516,976, filed on Jun. 8, 2017.
(60) Provisional application No. 62/516,965, filed on Jun. 8, 2017.
(60) Provisional application No. 62/516,969, filed on Jun. 8, 2017.

(30) Foreign Application Priority Data
Jun. 8, 2017 (WO) CN2017/087537
Jun. 8, 2017 (WO) CN2017/087538
Jun. 8, 2017 (WO) CN2017/087539
Jun. 9, 2017 (WO) CN2017/087707

(51) Int. Cl. C11D 3/50; C11D 3/40; C11D 3/20

(52) U.S. Cl. CPC C11D 3/50; C11D 3/2044; C11D 3/40

(57) ABSTRACT

Non-homogeneous liquid compositions that include an adjunct ingredient. Related methods of making and using such compositions.

### FIELD OF THE INVENTION

The present disclosure relates to non-homogeneous liquid compositions. The present disclosure further relates to processes of making and using such compositions.

### BACKGROUND OF THE INVENTION

Liquid consumer product compositions, such as liquid detergent or enhancer compositions, typically contain a variety of ingredients that must be combined to form the final product. Manufacturers often add these components together in batch processes or continuous loop processes and mix the resulting compositions in order to obtain homogeneous compositions. Homogeneous compositions may be desired for phase stability reasons and/or for compositional consistency from pallet to pallet, container to container, or even a consumer's use to use of the final product.

Such mixing may occur via static mixers and/or dynamic mixers. However, such mixing processes can increase processing time due to the time required to mix, capital costs due to the cost of the mixing machinery, and/or production space due to the additional area required to house the mixing machinery in a manufacturing plant.

When a homogeneous liquid composition is provided in a given package, it is typically characterized by consistent concentrations of adjunct ingredients (e.g., benefit agents) from dose to dose, or region to region in the package. While this consistency is often desired by the manufacturer for quality assurance purposes, it may lead to a static end-use benefit profile, where more dynamic benefit profiles may instead be desired.

On the other hand, poorly mixed products may suffer from poor phase stability, poor quality control, and/or poor performance across bottles or usages.

There is a need for non-homogeneous liquid compositions that are still characterized by good physical stability and/or performance benefits.

### SUMMARY OF THE INVENTION

The present disclosure relates to non-homogeneous liquid compositions. The compositions may be packaged compositions, disposed in a container.

The present disclosure further relates to a packaged, non-homogeneous liquid composition, the composition residing in a container, the composition being a single phase liquid composition, the composition including water and an adjunct selected from encapsulates, neat perfume, enzymes, fabric hueing agents, conditioning agents, fabric enhancement polymers, pearlescent agents, opacifiers, or mixtures thereof, where when the composition is divided into Large Samples according to the method described herein (Preparation of Large Samples), the first about 10% of the Large Samples are characterized by a first average adjunct concentration (Direct or Calculated) of the adjunct, and the last about 10% of the Large Samples are characterized by a second average adjunct concentration (Direct or Calculated, determined the same manner as the first average adjunct concentration) of the adjunct, where either: a) the first average adjunct concentration is at least about 1% greater than the second average adjunct concentration; or b) the first average adjunct concentration is at least about 1% less than the second average adjunct concentration. It may be that the first average adjunct concentration is not more than 25% greater or 25% less than the second average adjunct concentration.

The present disclosure also relates to a liquid composition, the liquid composition being disposed in a container, the liquid composition being a single phase liquid composition, the liquid composition including an adjunct ingredient, where when the composition is divided into Large Samples according to the method provided herein, the weighted mean adjunct concentration of the first 10% of Large Samples is at least 1%, or at least 2%, or at least 3%, or at least 5%, or at least 7.5%, or at least 10%, different from (e.g., greater than or less than) the mean adjunct concentration of all of the Large Samples.

The present disclosure also relates to a liquid composition, the liquid composition being disposed in a container, the liquid composition being a single phase liquid composition, the liquid composition comprising an adjunct ingredient, wherein the liquid composition is characterized by an Adjunct Variation Index, as determined according to the method provided herein, of equal to or less than 1.0, or equal to or less than 0.75, or equal to or less than 0.6, or equal to or less than 0.5, or equal to or less than 0.4, or equal to or less than 0.3, or equal to or less than 0.25, and preferably at least equal to or greater than 0.1.

The present disclosure also relates to a method of treating a surface, the method including the step of contacting a surface, preferably a fabric, with a composition as described herein.

### BRIEF DESCRIPTION OF THE DRAWINGS

The figures herein are illustrative in nature and are not intended to be limiting.

FIG. 1 shows a schematic diagram representing dividing a packaged product into Large Samples, each of which is then sub-divided into Small Samples.

FIG. 2 shows a schematic diagram of a non-homogeneous composition in a container, including zoomed-in schematic diagrams of different regions of the composition.

FIG. 3 shows a perspective view of a container according to the present disclosure.

FIG. 4 shows a side view of a container according to the present disclosure.

### DETAILED DESCRIPTION OF THE INVENTION

The present disclosure relates to non-homogeneous compositions. More particularly, the compositions are non-homogeneous with regard to an adjunct ingredient. The adjunct ingredient may be non-homogeneously dispersed throughout the composition. However, the composition as a whole (e.g., as a final product in a container) may be phase stable.

Such product compositions may be obtained by providing a base composition and adding certain adjunct ingredients without fully mixing them in. However, the final product composition should not be so heterogeneous as to become phase unstable or physically separate.

Such non-homogeneous compositions may be advantageous to a manufacturer, because additional time, capital, and/or floor space are not necessary for complete mixing of the product.

Furthermore, such non-homogeneous compositions may be designed to suit certain needs or desires of the end-use consumer. In particular, it may be desirable to provide liquid compositions that offer a dynamic benefit profile over the life span of the product. For example, it may be desirable for the concentration of an adjunct ingredient to systematically vary, for example along a concentration gradient, from the first doses to the last doses, as dispensed from a given container.

For example, a non-homogeneous composition according to the present disclosure may be provided having a greater concentration of an adjunct ingredient in the first dose(s) used by that consumer compared to the last dose(s). Such a composition may be useful for providing a particularly impactful benefit upon the first use(s), and then, e.g., maintenance levels of the adjunct thereafter. This may be particularly preferred if a consumer orders a customized composition manufactured to his/her personal preference—the increased levels of adjunct upon first use signals to the consumer that this product is indeed personal to him/her. For example, a composition may be provided having a greater concentration of perfume in the first dose(s) than the last dose(s). Such compositions may also be preferred if the adjunct is a benefit agent intended to be deposited onto a target surface, such a fabric; the first use(s) can provide a “base” layer on the target surface and subsequent uses may provide maintenance or restorative amounts of the adjunct.

A non-homogeneous composition according to the present disclosure may be provided having a lesser concentration of an adjunct ingredient in the first dose(s) used by a consumer compared to the last dose(s). For example, a composition may be provided having a greater concentration of perfume in the last dose(s) than the first dose(s). Delivering increased amounts of a benefit agent over time can reinforce a consumer's perception of the quality of a product, making the consumer more likely to repurchase the product in the future, particularly if a strong performance benefit is achieved upon the last use of the product. Such compositions may also be desirable to combat a consumer's habituation to a benefit agent over time—greater amounts of the adjunct are required to provide the same consumer perception of the benefit.

Compositions and processes of the present disclosure are described in more detail below.

As used herein, the articles “a” and “an” when used in a claim, are understood to mean one or more of what is claimed or described. As used herein, the terms “include,” “includes,” and “including” are meant to be non-limiting. The compositions of the present disclosure can comprise, consist essentially of, or consist of, the components of the present disclosure.

The terms “substantially free of” or “substantially free from” may be used herein. This means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or less than 0.1%, or less than 0.01%, or even 0%, by weight of the composition.

As used herein, the term “cleaning composition” includes, unless otherwise indicated, liquid, gel or paste-form all-purpose washing agents, especially the so-called heavy-duty liquid types; liquid fine-fabric detergents; hand dishwashing agents or light duty dishwashing agents, especially those of the high-foaming type; machine dishwashing agents, including the various pouches, liquid and rinse-aid types for household and institutional use; liquid cleaning and disinfecting agents, including antibacterial hand-wash types, mouthwashes, denture cleaners, dentifrice, car or carpet shampoos, bathroom cleaners; hair shampoos and hair-rinses; shower gels and foam baths and metal cleaners; as well as cleaning auxiliaries such as bleach additives and pre-treatment compositions; as well as sprays and mists.

As used herein the phrase “fabric care composition” includes compositions and formulations designed for treating fabric. Such compositions include but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, unit dose formulation, delayed delivery formulation, detergent contained on or in a porous substrate or nonwoven sheet, and other suitable forms that may be apparent to one skilled in the art in view of the teachings herein. Such compositions may be used as a pre-laundering treatment, a post-laundering treatment, or may be added during the rinse or wash cycle of the laundering operation.

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (° C.) unless otherwise indicated. Unless otherwise specified, all measurements herein are conducted at 20° C. and under the atmospheric pressure.

In all embodiments of the present disclosure, all percentages are by weight of the total composition, unless specifically stated otherwise. All ratios are weight ratios, unless specifically stated otherwise.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Compositions

The present disclosure relates to non-homogeneous compositions. The compositions may be consumer product compositions.

Suitable consumer product compositions may include, but are not limited to, compositions for treating hair (human, dog, and/or cat), including bleaching, coloring, dyeing, conditioning, growing, removing, retarding growth, shampooing, and/or styling; deodorants and antiperspirants; personal cleansing; color cosmetics; products, and/or methods relating to treating skin (human, dog, and/or cat), including application of creams, lotions, and other topically applied products for consumer use; products and/or methods relating to orally administered materials for enhancing the appearance of hair, skin, and/or nails (human, dog, and/or cat); shaving; body sprays; fine fragrances like colognes and perfumes; compositions for treating fabrics, hard surfaces and any other surfaces in the area of fabric and home care, including air care, car care, dishwashing, fabric conditioning (including softening), laundry detergency, laundry and rinse additive and/or care, hard surface cleaning and/or treatment, and other cleaning for consumer or institutional use; hand soaps, shampoos, lotions, oral care compositions, such as toothpaste and/or tooth whitening compositions.

The compositions of the present disclosure may be fabric care compositions, hard surface cleaning compositions, dishwashing compositions, air care compositions, and/or hair care compositions, more preferably a fabric care composition, a hard surface cleaning composition, a dishwashing composition, and/or an air care composition. The composition may be a fabric care composition. The fabric care composition may be a laundry detergent, a fabric enhancing composition, or a mixture thereof. The fabric care composition may be a laundry detergent, such as a heavy duty liquid laundry detergent.

The compositions of the present disclosure may have any suitable form. The composition may be in a form selected from a liquid, a gel, a paste, or a unit dose article (single- or multi-compartmented) containing any of the above, or combinations thereof. The compositions of the present disclosure may be flowable compositions. The compositions may be liquid or gel, preferably liquid. The composition may be a heavy duty liquid laundry detergent, a liquid fabric enhancing composition, or combinations thereof, preferably a heavy duty liquid laundry detergent.

The compositions of the present disclosure may be in a form selected from the group consisting of a liquid laundry detergent, a gel detergent, a detergent contained in a single-phase or multi-phase or multi-compartment water soluble pouch, a liquid hand dishwashing composition, a laundry pretreat product, a fabric softener or enhancer composition, and mixtures thereof.

The liquid compositions of the present disclosure may have a viscosity of from about about 1 to about 2000 mPa*s at 25° C. and a shear rate of 20 sec-¹. The viscosity of the liquid may be in the range of from about 200 to about 1000 mPa*s at 25° C. at a shear rate of 20 sec-¹. The viscosity of the liquid may be in the range of from about 200 to about 500 mPa*s at 25° C. at a shear rate of 20 sec-¹.

The compositions of the present disclosure may be suitable for being contained in a container, preferably a bottle, as described in more detail below.

The compositions of the present disclosure may comprise a variety of ingredients, such as surfactant and/or adjunct ingredients. The composition may comprise an adjunct ingredient and a carrier, which may be water and/or organic solvent. Suitable ingredients are described in more detail below.

The compositions of the present disclosure are non-homogeneous with regard to the distribution of adjunct ingredient(s) in the composition as contained in the container. Put another way, the concentration of an adjunct ingredient in the composition is not uniform throughout the composition—some regions have higher concentrations, while other regions have lower concentrations.

The non-homogeneous compositions may result from combining adjunct ingredients to a base composition late in the manufacturing process and/or minimal purposeful mixing, e.g., without dedicated static or dynamic mixing equipment. The base composition and adjunct may be combined in the final product container or in a nozzle immediately prior to filling the final product container.

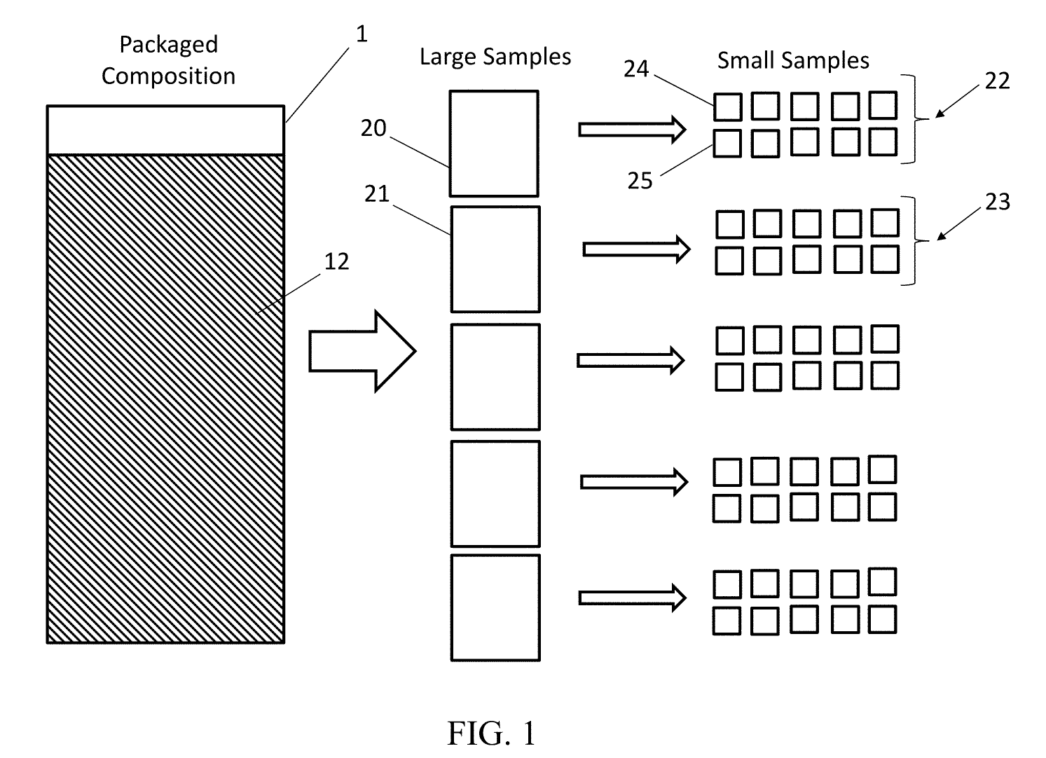

The non-homogeneity of the present compositions may be described in a number of ways, and test methods and relevant calculations are provided in the Test Methods section below. As described below (see Test Methods, section I) and shown schematically in FIG. 1, a composition 12 in a container 1, such as a bottle in which the composition is sold, is divided into “Large Samples,” 20, 21, which each may then be sub-divided into populations 22, 23 or pluralities of “Small Samples” 24, 25. Efforts should be taken to ensure that the amounts (e.g., volume or mass) of the Large Samples derived from a given composition are approximately the same, i.e., +/−5% of each other. Efforts should be taken to ensure that the amounts (e.g., volume or mass) of the Small Samples derived from a given Large Sample are approximately the same, i.e., +/−5% of each other.

The concentration of an adjunct ingredient may be determined in the Large Samples and/or the Small Samples by an appropriate method (see, e.g., Test Methods, section II, below), and the analysis method itself may have a known or determinable relative standard deviation. The selected adjunct may be an adjunct selected from encapsulates, neat perfume, enzymes, dye (including fabric hueing agents), conditioning agents, fabric enhancement polymers, pearlescent agents, opacifiers, or mixtures thereof.

The adjunct concentration of a Large Sample may be determined directly (see Test Methods, sections II and III), or it may be calculated according to the adjunct concentrations of the Small Samples resulting from the Large Sample (see Test Methods, sections II and IV).

Based on the adjunct concentrations determined from the Small Samples, an Adjunct Variation Index (“AVI”) for a product composition can be determined; see Test Methods, section V. In sum, the AVI is a comparison of the mean relative standard deviations of the populations of Small Samples (MRSD-S) versus the relative standard deviation of the population of the Large Samples (RSD-L), determined from the Calculated Adjunct Concentrations of the Large Samples. Without wishing to be bound by theory, it is believed that an AVI value of less than 1.0 indicates the adjunct is well-dispersed locally, for example dissolved or dispersed into small particles or droplets, but may not be well-distributed throughout the bottle.

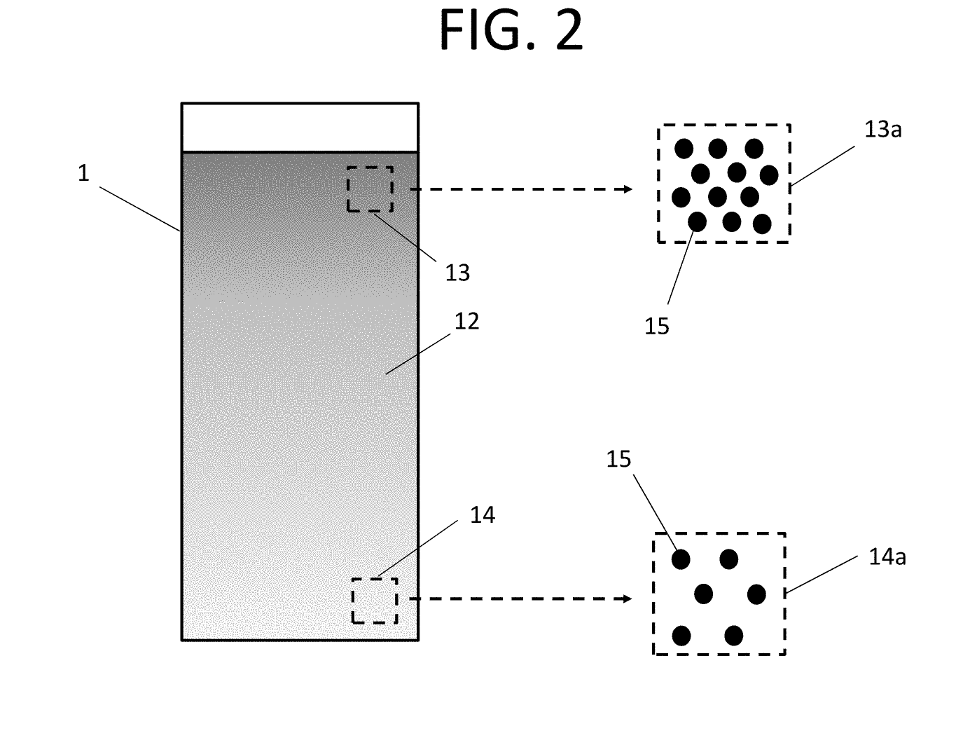

For example, FIG. 2 schematically shows a container 1 that contains a composition 12. The shading of the composition 12 is intended to show a relatively high concentration of an adjunct ingredient 15 near the top of the container (and/or in the first doses used by a consumer), and a relatively low concentration of the adjunct ingredient 15 near the container (and/or in the last doses used by a consumer). More specifically, a first portion 13 of the composition 12 is shown near the top of the container 1. A second portion 14 of the composition 12 is shown near the bottom of the container 1. Boxes 13a and 14a show schematic representations of the relative concentrations of an adjunct ingredient 15, such as perfume or perfume microcapsules, in each portion 13, 14. The adjunct ingredient 15 is relatively concentrated in the first portion 13, as visually represented in box 13a. The adjunct ingredient 15 is relatively less concentrated in the second portion 14, as visually represented in box 14a. Within each portion 13a, 14a, the adjunct ingredient 15 is well-dispersed, but when viewed as a whole, the adjunct 15 is unevenly distributed through the container 1 (i.e., a higher concentration at the top than at the bottom). One of ordinary skill can easily envision a different situation, where an adjunct ingredient 15 is relatively highly concentrated in the bottom of a container (or in the last doses used by a consumer) compared to a relatively lower concentration in the top of the container (or in the first doses used by a consumer).

The AVI of compositions according to the present disclosure may be characterized by an AVI of less than 1.0, or equal to or less than 0.75, or equal to or less than 0.6, or equal to or less than 0.5, or equal to or less than 0.4, or equal to or less than 0.3, or equal to or less than 0.25.

The compositions of the present disclosure may be characterized by differences in relative concentration in different regions of a container and/or in different doses of the composition. See Test Methods, section VI. After dividing a composition into sequential Large Samples, the weighted average of the adjunct concentration in the first 10% of Large Samples may be compared to the weighted average of the adjunct concentration in the last 10% of Large Samples. The first and last 10% of Large Samples may be used as a proxy for the first and last doses, respectively, of the composition used or experienced by the consumer. The first and last 10% of Large Samples may be used as a proxy for the composition at the top and bottom of the container (if the open end of the container is near the top), respectively.

The weighted average of the adjunct concentration of a portion of the Large Samples may be compared to the mean adjunct concentration of all the Large Samples (i.e., the calculated mean concentration of the composition in the container). The weighted mean adjunct concentration of the first 10% of Large Samples may be at least 1%, or at least 2%, or at least 3%, or at least 5%, or at least 7.5%, or at least 10%, greater than the mean adjunct concentration of all of the Large Samples. The weighted mean adjunct concentration of the first 10% of Large Samples may be at least 1%, or at least 2%, or at least 3%, or at least 5%, or at least 7.5%, or at least 10%, less than the mean adjunct concentration of all of the Large Samples. The weighted mean adjunct concentration of the last 10% of Large Samples may be at least 1%, or at least 2%, or at least 3%, or at least 5%, or at least 7.5%, or at least 10%, greater than the mean adjunct concentration of all of the Large Samples. The weighted mean adjunct concentration of the last 10% of Large Samples may be at least 1%, or at least 2%, or at least 3%, or at least 5%, or at least 7.5%, or at least 10%, less than the mean adjunct concentration of all of the Large Samples.

The concentration of an adjunct may be relatively greater in the first doses compared to the concentration in the last doses. Providing an increased level of an adjunct in the first dose(s) may provide the consumer with an immediately favorable impression of the product. When the product has been customized to a consumer, the increased level of the adjunct in the first dose(s) may provide the consumer with confirmation that the product is indeed the desired custom-ordered product. Additionally, increased levels of an adjunct, particularly adjuncts that are intended to deposit on a target surface, in the first dose(s) of a product may provide a sufficient “base layer” upon the target surface, such as a fabric, whereas subsequent doses of the composition, which have relatively lower levels of the adjunct, may provide “maintenance” levels of the adjunct. The adjuncts may include an adjunct selected from encapsulates, neat perfume, enzymes, fabric hueing agents, conditioning agents, fabric enhancement polymers, pearlescent agents, opacifiers, or mixtures thereof. The weighted mean adjunct concentration of the first 10% of Large Samples may be at least 1%, or at least 2%, or at least 3%, or at least 5%, or at least 7.5%, or at least 10%, greater than the weighted mean adjunct concentration of the last 10% of Large Samples. The weighted mean adjunct concentration of the first 10% of Large Samples may be compared to the average concentration and/or relative standard deviation of the Large Samples, as described below. See, e.g., Test Methods, section VI.

The concentration of an adjunct may be relatively greater in the last doses compared to the concentration in the first doses. Increasing the amount of benefit agent delivered across usages can reinforce a consumer's perception of the quality of a product, making the consumer more likely to repurchase the product in the future, particularly if a strong performance benefit is achieved upon the last use of the product. Such compositions may also be desirable to combat a consumer's habituation to a benefit agent over time—greater amounts of the adjunct are required to provide the same consumer perception of the benefit. Additionally, very few consumers wash a textile (e.g., an article of clothing) only once, and it is assumed that soils leading to discoloration, dinginess, and/or malodor may build up on the textile upon repeated uses, even when the textile is washed between uses. Therefore, it may be advantageous to provide a composition having a greater concentration of adjunct ingredients in the last dose(s) to better counteract this buildup of soils. The adjuncts may be an adjunct selected from encapsulates, neat perfume, enzymes, fabric hueing agents, conditioning agents, fabric enhancement polymers, pearlescent agents, opacifiers, or mixtures thereof, preferably neat perfume, encapsulates, a dye and/or a hueing agent, or a mixture thereof. The weighted mean adjunct concentration of the last 10% of Large Samples may be at least 1%, or at least 2%, or at least 3%, or at least 5%, or at least 7.5%, or at least 10%, greater than the weighted mean adjunct concentration of the first 10% of Large Samples. The weighted mean adjunct concentration of the last 10% of Large Samples may be compared to the average concentration and/or relative standard deviation of the Large Samples, as described below. See, e.g., Test Methods, section VI.

The weighted mean adjunct concentration of the first 10% of Large Samples may be at least 1%, or at least 2%, or at least 3%, or at least 5%, or at least 7.5%, or at least 10%, different from the mean adjunct concentration of all of the Large Samples. The weighted mean adjunct concentration of the first 10% of Large Samples may be at least 1%, or at least 2%, or at least 3%, or at least 5%, or at least 7.5%, or at least 10%, greater than the mean adjunct concentration of all of the Large Samples. The weighted mean adjunct concentration of the first 10% of Large Samples may be at least 1%, or at least 2%, or at least 3%, or at least 5%, or at least 7.5%, or at least 10%, less than the mean adjunct concentration of all of the Large Samples.

The relative standard deviation of the adjunct concentration in Large Samples of a packaged non-homogeneous composition may change over time, such as during the course of storage. See Test Methods, section VII. If the relative standard deviation increases over time, this may indicate that the composition is becoming more non-homogeneous (i.e., more heterogeneous), which may lead to phase instability. If the relative standard deviation remains the same or decreases over time, this may indicate that the composition is phase stable and/or becoming less non-homogeneous (e.g., more homogeneous) over time. The ratio of the relative standard deviation of an aged product composition compared to the relative standard deviation of a “new” composition may be equal to or less than about 1, or equal to or less than about 0.9, or equal to or less than about 0.8, or equal to or less than about 0.75. The composition may be aged for any suitable period of time, such as two weeks at 20° C.

The relative standard deviation of the adjunct concentration of the Large Samples of a particular product composition may be compared to the relative standard deviation of the method used to determine the adjunct concentration. If the tested product is relatively non-homogeneous, it is expected that the ratio of the relative standard deviation of the product is greater than the relative standard deviation of the method, i.e., that the ratio of the two will be greater than 1. It may be preferred that the ratio is at least about 1.1, or at least about 1.2, or at least about 1.3, or at least about 1.4, or at least about 1.5. See Test Methods, section VIII. A composition may be characterized by a ratio of the relative standard deviation of the product (adjunct concentration in the Large Samples) to the relative standard deviation of the method is at least about 1.1, and that the ratio of the relative standard deviation of aged product to the relative standard deviation of new product is equal to or less than about 1. This may indicate that the product is substantially non-homogeneous at a given point in time, but that the product either stays the same or increases in homogeneity over time, indicating good product stability.

Although the compositions of the present disclosure are non-homogeneous, the compositions are typically phase stable. The composition may visually appear as a single phase. By “single phase”, it is meant that the composition appears as a single phase (i.e., appears homogeneous to the naked eye) in a clear container (such as a glass jar), after storage for 24 hours at 20° C. with no mixing or shaking, when viewed from a distance of one meter in a clear container, under lighting conditions that simulate that of a typical North American supermarket.

The compositions may be phase stable, as determined by the following method: 300 mL of the composition is placed in a glass jar for a time period up to 21 days at 20° C. The composition is considered phase stable if, with in the time period, (i) the composition is free from splitting into two or more layers, or (ii) the composition splits into layers, where a major layer comprises at least 90%, preferably 95%, by weight of the composition.

Suitable components of the present compositions are described in more detail below.

Surfactant

The compositions disclosed herein may comprise a surfactant selected from the group consisting of anionic surfactants, nonionic surfactants, cationic surfactants, zwitterionic surfactants, amphoteric surfactants, ampholytic surfactants, and mixtures thereof.

Anionic Surfactant

The compositions of the present disclosure may comprise at least about 1%, or at least about 5%, or at least about 7%, or at least about 10%, or at least about 20%, or at least about 30%, or at least about 50%, or at least about 60%, or at least about 70% by weight of an anionic surfactant. The compositions of the present disclosure may comprise less than 100%, or less than 90%, or less than about 85%, or less than about 75%, or less than about 70% by weight of an anionic surfactant. The compositions of the present disclosure may comprise from about 1% to about 70%, or from about 5% to about 50%, or from about 20% to about 70%, or about 30% to about 75%, or about 30% to about 65%, or about 35% to about 65%, or about 40% to about 60%, of an anionic surfactant.

The anionic surfactants may exist in an acid form, and the acid form may be neutralized to form a surfactant salt. Typical agents for neutralization include metal counterion bases, such as hydroxides, e.g., NaOH or KOH. Further suitable agents for neutralizing anionic surfactants in their acid forms include ammonia, amines, or alkanolamines. Non-limiting examples of alkanolamines include monoethanolamine, diethanolamine, triethanolamine, and other linear or branched alkanolamines known in the art; suitable alkanolamines include 2-amino-1-propanol, 1-aminopropanol, monoisopropanolamine, or 1-amino-3-propanol. Amine neutralization may be done to a full or partial extent, e.g., part of the anionic surfactant mix may be neutralized with sodium or potassium and part of the anionic surfactant mix may be neutralized with amines or alkanolamines.

Non-limiting examples of suitable anionic surfactants include any conventional anionic surfactant. This may include a sulfate detersive surfactant, for e.g., alkoxylated and/or non-alkoxylated alkyl sulfate materials, and/or sulfonic detersive surfactants, e.g., alkyl benzene sulfonates. Suitable anionic surfactants may be derived from renewable resources, waste, petroleum, or mixtures thereof. Suitable anionic surfactants may be linear, partially branched, branched, or mixtures thereof

Alkoxylated alkyl sulfate materials comprise ethoxylated alkyl sulfate surfactants, also known as alkyl ether sulfates or alkyl polyethoxylate sulfates. Examples of ethoxylated alkyl sulfates include water-soluble salts, particularly the alkali metal, ammonium and alkylolammonium salts, of organic sulfuric reaction products having in their molecular structure an alkyl group containing from about 8 to about 30 carbon atoms and a sulfonic acid and its salts. (Included in the term “alkyl” is the alkyl portion of acyl groups. In some examples, the alkyl group contains from about 15 carbon atoms to about 30 carbon atoms. In other examples, the alkyl ether sulfate surfactant may be a mixture of alkyl ether sulfates, said mixture having an average (arithmetic mean) carbon chain length within the range of about 12 to 30 carbon atoms, and in some examples an average carbon chain length of about 12 to 15 carbon atoms, and an average (arithmetic mean) degree of ethoxylation of from about 1 mol to 4 mols of ethylene oxide, and in some examples an average (arithmetic mean) degree of ethoxylation of 1.8 mols of ethylene oxide. In further examples, the alkyl ether sulfate surfactant may have a carbon chain length between about 10 carbon atoms to about 18 carbon atoms, and a degree of ethoxylation of from about 1 to about 6 mols of ethylene oxide. In yet further examples, the alkyl ether sulfate surfactant may contain a peaked ethoxylate distribution.

Non-alkoxylated alkyl sulfates may also be added to the disclosed detergent compositions and used as an anionic surfactant component. Examples of non-alkoxylated, e.g., non-ethoxylated, alkyl sulfate surfactants include those produced by the sulfation of higher C₈-C₂₀ fatty alcohols. In some examples, primary alkyl sulfate surfactants have the general formula: ROSO₃⁻M⁺, wherein R is typically a linear C₈-C₂₀ hydrocarbyl group, which may be straight chain or branched chain, and M is a water-solubilizing cation. In some examples, R is a C₁₀-C₁₈ alkyl, and M is an alkali metal. In other examples, R is a C₁₂/C₁₄ alkyl and M is sodium, such as those derived from natural alcohols.

Other useful anionic surfactants can include the alkali metal salts of alkyl benzene sulfonates, in which the alkyl group contains from about 9 to about 15 carbon atoms, in straight chain (linear) or branched chain configuration. In some examples, the alkyl group is linear. Such linear alkylbenzene sulfonates are known as “LAS.” In other examples, the linear alkylbenzene sulfonate may have an average number of carbon atoms in the alkyl group of from about 11 to 14. In a specific example, the linear straight chain alkyl benzene sulfonates may have an average number of carbon atoms in the alkyl group of about 11.8 carbon atoms, which may be abbreviated as C11.8 LAS.

Suitable alkyl benzene sulphonate (LAS) may be obtained, by sulphonating commercially available linear alkyl benzene (LAB); suitable LAB includes low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®. A suitable anionic detersive surfactant is alkyl benzene sulphonate that is obtained by DETAL catalyzed process, although other synthesis routes, such as HF, may also be suitable. In one aspect a magnesium salt of LAS is used.

Another example of a suitable alkyl benzene sulfonate is a modified LAS (MLAS), which is a positional isomer that contains a branch, e.g., a methyl branch, where the aromatic ring is attached to the 2 or 3 position of the alkyl chain.

The anionic surfactant may include a 2-alkyl branched primary alkyl sulfates have 100% branching at the C2 position (C1 is the carbon atom covalently attached to the alkoxylated sulfate moiety). 2-alkyl branched alkyl sulfates and 2-alkyl branched alkyl alkoxy sulfates are generally derived from 2-alkyl branched alcohols (as hydrophobes). 2-alkyl branched alcohols, e.g., 2-alkyl-1-alkanols or 2-alkyl primary alcohols, which are derived from the oxo process, are commercially available from Sasol, e.g., LIAL®, ISALCHEM® (which is prepared from LIAL® alcohols by a fractionation process). C14/C15 branched primary alkyl sulfate are also commercially available, e.g., namely LIAL® 145 sulfate.

The anionic surfactant may include a mid-chain branched anionic surfactant, e.g., a mid-chain branched anionic detersive surfactant, such as, a mid-chain branched alkyl sulphate and/or a mid-chain branched alkyl benzene sulphonate.

Additional suitable anionic surfactants include methyl ester sulfonates, paraffin sulfonates, α-olefin sulfonates, and internal olefin sulfonates.

The compositions disclosed herein may comprise an anionic surfactant selected from the group consisting of linear or branched alkyl benzene sulfonates, linear or branched alkoxylated alkyl sulfates, linear or branched alkyl sulfates, methyl ester sulfonates, paraffin sulfonates, α-olefin sulfonates, internal olefin sulfonates, and mixtures thereof. The compositions disclosed herein may comprise an anionic surfactant selected from the group consisting of linear or branched alkyl benzene sulfonates, linear or branched alkoxylated alkyl sulfates, linear or branched alkyl sulfates, and mixtures thereof. The compositions disclosed herein may comprise a 2-alkyl branched primary alkyl sulfate.

Nonionic Surfactant

The compositions disclosed herein may comprise a nonionic surfactant. Suitable nonionic surfactants include alkoxylated fatty alcohols. The nonionic surfactant may be selected from ethoxylated alcohols and ethoxylated alkyl phenols of the formula R(OC₂H₄)ₙOH, wherein R is selected from the group consisting of aliphatic hydrocarbon radicals containing from about 8 to about 15 carbon atoms and alkyl phenyl radicals in which the alkyl groups contain from about 8 to about 12 carbon atoms, and the average value of n is from about 5 to about 15.

Other non-limiting examples of nonionic surfactants useful herein include: C₈-C₁₈ alkyl ethoxylates, such as, NEODOL® nonionic surfactants from Shell; C₆-C₁₂ alkyl phenol alkoxylates where the alkoxylate units may be ethyleneoxy units, propyleneoxy units, or a mixture thereof; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols, BA; C₁₄-C₂₂ mid-chain branched alkyl alkoxylates, BAEₓ, wherein x is from 1 to 30; alkylpolysaccharides; specifically alkylpolyglycosides; polyhydroxy fatty acid amides; and ether capped poly(oxyalkylated) alcohol surfactants.

Suitable nonionic detersive surfactants also include alkyl polyglucoside and alkyl alkoxylated alcohol. Suitable nonionic surfactants also include those sold under the tradename Lutensol® from BASF.

Cationic Surfactant

The compositions disclosed herein may comprise a cationic surfactant. Non-limiting examples of cationic surfactants include: the quaternary ammonium surfactants, which can have up to 26 carbon atoms include: alkoxylate quaternary ammonium (AQA) surfactants; dimethyl hydroxyethyl quaternary ammonium; dimethyl hydroxyethyl lauryl ammonium chloride; polyamine cationic surfactants; cationic ester surfactants; and amino surfactants, e.g., amido propyldimethyl amine (APA).

Suitable cationic detersive surfactants also include alkyl pyridinium compounds, alkyl quaternary ammonium compounds, alkyl quaternary phosphonium compounds, alkyl ternary sulphonium compounds, and mixtures thereof.

Suitable cationic detersive surfactants are quaternary ammonium compounds having the general formula:

(R)(R₁)(R₂)(R₃)N⁺X⁻

wherein, R is a linear or branched, substituted or unsubstituted C₆₋₁₈ alkyl or alkenyl moiety, R₁ and R₂ are independently selected from methyl or ethyl moieties, R₃ is a hydroxyl, hydroxymethyl or a hydroxyethyl moiety, X is an anion which provides charge neutrality, suitable anions include: halides, for example chloride; sulphate; and sulphonate. Suitable cationic detersive surfactants are mono-C₆₋₁₈ alkyl mono-hydroxyethyl di-methyl quaternary ammonium chlorides. Highly suitable cationic detersive surfactants are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride.

Zwitterionic Surfactant

The compositions disclosed herein may comprise a zwitterionic surfactant. Examples of zwitterionic surfactants include: derivatives of secondary and tertiary amines, derivatives of heterocyclic secondary and tertiary amines, or derivatives of quaternary ammonium, quaternary phosphonium or tertiary sulfonium compounds. Suitable examples of zwitterionic surfactants include betaines, including alkyl dimethyl betaine and cocodimethyl amidopropyl betaine, C₈ to C₁₈ (for example from C₁₂ to C₁₈) amine oxides, and sulfo and hydroxy betaines, such as N-alkyl-N,N-dimethylammino-1-propane sulfonate where the alkyl group can be C₈ to C₁₈.

Amphoteric Surfactant

The compositions disclosed herein may comprise an amphoteric surfactant. Examples of amphoteric surfactants include aliphatic derivatives of secondary or tertiary amines, or aliphatic derivatives of heterocyclic secondary and tertiary amines in which the aliphatic radical may be straight or branched-chain and where one of the aliphatic substituents contains at least about 8 carbon atoms, or from about 8 to about 18 carbon atoms, and at least one of the aliphatic substituents contains an anionic water-solubilizing group, e.g. carboxy, sulfonate, sulfate. Suitable amphoteric surfactants also include sarcosinates, glycinates, taurinates, and mixtures thereof.

Adjunct Ingredients

The compositions disclosed herein, particularly the dilute and compacted fluid detergents that are suitable for sale to consumers (final products), may comprise adjunct ingredients. The adjunct ingredients may be present at any suitable level, preferably a level suitable to provide a performance benefit. The adjunct ingredients may be present, individually or collectively, in the compositions of the present disclosure at a level of from about 0.00001%, or from about 0.0001%, or from about 0.001%, or from about 0.01%, or from about 0.1%, or from about 1%, to about 50%, or to about 40%, or to about 30%, or to about 20%, or to about 15%, or to about 10%, or to about 8%, or to about 6%, or to about 5%, or to about 4%, or to about 3%, or to about 2%, or to about 1%, by weight of the composition. The adjunct ingredient may be present at a level of from about 0.001% to about 10%, by weight of the composition.

The compositions disclosed herein may comprise an adjunct selected from the group consisting of a structurant, a builder, an organic polymeric compound, an enzyme, an enzyme stabilizer, a bleach system, a brightener, a hueing agent, a chelating agent, a suds suppressor, a conditioning agent, a humectant, a perfume, a perfume microcapsule, a filler or carrier, an alkalinity system, a pH control system, a buffer, an alkanolamine, and mixtures thereof.

The compositions of the present disclosure may comprise an adjunct selected from encapsulates, neat perfume, enzymes, fabric hueing agents, conditioning agents, fabric enhancement polymers, pearlescent agents, opacifiers, or mixtures thereof.

The compositions of the present disclosure may further comprise a structurant or thickener which may be useful to maintain the non-homogeneity of the present compositions, e.g., by “locking” the components into place. Structurants may also be useful to maintain stability and/or to suspend benefit agents.

The compositions of the present disclosure may further comprise water.

These components are discussed in more detail below.

Encapsulates

The compositions may comprise an encapsulate. The encapsulate may comprise a core, a shell having an inner and outer surface, where the shell encapsulates the core.

The encapsulate may comprise a core and a shell, where the core comprises a material selected from perfumes; brighteners; dyes; insect repellants; silicones; waxes; flavors; vitamins; fabric softening agents; skin care agents, e.g., paraffins; enzymes; anti-bacterial agents; bleaches; sensates; or mixtures thereof; and where the shell comprises a material selected from polyethylenes; polyamides; polyvinylalcohols, optionally containing other co-monomers; polystyrenes; polyisoprenes; polycarbonates; polyesters; polyacrylates; polyolefins; polysaccharides, e.g., alginate and/or chitosan; gelatin; shellac; epoxy resins; vinyl polymers; water insoluble inorganics; silicone; aminoplasts, or mixtures thereof. When the shell comprises an aminoplast, the aminoplast may comprise polyurea, polyurethane, and/or polyureaurethane. The polyurea may comprise polyoxymethyleneurea and/or melamine formaldehyde.

The encapsulate may comprise a core, and the core may comprise a perfume. The encapsulate may comprise a shell, and the shell may comprise melamine formaldehyde and/or cross linked melamine formaldehyde. The encapsulate may comprise a core comprising a perfume and a shell comprising melamine formaldehyde and/or cross linked melamine formaldehyde

Suitable encapsulates may comprise a core material and a shell, where the shell at least partially surrounds the core material. The core of the encapsulate comprises a material selected from a perfume raw material and/or optionally another material, e.g., vegetable oil, esters of vegetable oils, esters, straight or branched chain hydrocarbons, partially hydrogenated terphenyls, dialkyl phthalates, alkyl biphenyls, alkylated naphthalene, petroleum spirits, aromatic solvents, silicone oils, or mixtures thereof.

The wall of the encapsulate may comprise a suitable resin, such as the reaction product of an aldehyde and an amine. Suitable aldehydes include formaldehyde. Suitable amines include melamine, urea, benzoguanamine, glycoluril, or mixtures thereof. Suitable melamines include methylol melamine, methylated methylol melamine, imino melamine and mixtures thereof. Suitable ureas include, dimethylol urea, methylated dimethylol urea, urea-resorcinol, or mixtures thereof.

Suitable formaldehyde scavengers may be employed with the encapsulates, for example, in a capsule slurry and/or added to a composition before, during, or after the encapsulates are added to such composition.

Suitable capsules can be purchased from Appleton Papers Inc. of Appleton, Wis. USA.

Neat Perfume

Perfumes and perfumery ingredients may be used in the detergent compositions described herein. Non-limiting examples of perfume and perfumery ingredients include, but are not limited to, aldehydes, ketones, esters, and the like. Other examples include various natural extracts and essences which can comprise complex mixtures of ingredients, such as orange oil, lemon oil, rose extract, lavender, musk, patchouli, balsamic essence, sandalwood oil, pine oil, cedar, and the like. Finished perfumes can comprise extremely complex mixtures of such ingredients. Finished perfumes may be included at a concentration ranging from about 0.01% to about 2% by weight of the detergent composition.

Perfume may be delivered neat or as part of a perfume premix such as in combination with an organic solvent, and/or as an emulsion in water; nonionic surfactant may act as an emulsifier.

As used herein, the term “perfume” encompasses the perfume raw materials (PRMs) and perfume accords. The term “perfume raw material” as used herein refers to compounds having a molecular weight of at least about 100 g/mol and which are useful in imparting an odor, fragrance, essence or scent, either alone or with other perfume raw materials. As used herein, the terms “perfume ingredient” and “perfume raw material” are interchangeable. The term “accord” as used herein refers to a mixture of two or more PRMs.

Typical PRM comprise inter alia alcohols, ketones, aldehydes, esters, ethers, nitrites and alkenes, such as terpene. A listing of common PRMs can be found in various reference sources, for example, “Perfume and Flavor Chemicals”, Vols. I and II; Steffen Arctander Allured Pub. Co. (1994) and “Perfumes: Art, Science and Technology”, Miller, P. M. and Lamparsky, D., Blackie Academic and Professional (1994).

The PRMs are characterized by their boiling points (B.P.) measured at the normal pressure (760 mm Hg), and their octanol/water partitioning coefficient (P). Based on these characteristics, the PRMS may be categorized as Quadrant I, Quadrant II, Quadrant III, or Quadrant IV perfumes, as described in more detail below.

Octanol/water partitioning coefficient of a PRM is the ratio between its equilibrium concentration in octanol and in water. The log P of many PRMs has been reported; for example, the Pomona92 database, available from Daylight Chemical Information Systems, Inc. (Daylight CIS), Irvine, Calif., contains many, along with citations to the original literature. However, the log P values are most conveniently calculated by the “C LOG P” program, also available from Daylight CIS. This program also lists experimental log P values when they are available in the Pomona92 database. The “calculated log P” (C log P) is determined by the fragment approach on Hansch and Leo (cf., A. Leo, in Comprehensive Medicinal Chemistry, Vol. 4, C. Hansch, P. G. Sammens, J. B. Taylor and C. A. Ransden, Eds., p. 295, Pergamon Press, 1990, incorporated herein by reference). The fragment approach is based on the chemical structure of each PRM, and takes into account the numbers and types of atoms, the atom connectivity, and chemical bonding. The C log P values, which are the most reliable and widely used estimates for this physicochemical property, are preferably used instead of the experimental log P values in the selection of PRMs which are useful in the present invention.

The boiling points of many PRMs are given in, e.g., “Perfume and Flavor Chemicals (Aroma Chemicals),” S. Arctander, published by the author, 1969, incorporated herein by reference. Other boiling point values can be obtained from different chemistry handbooks and databases, such as the Beilstein Handbook, Lange's Handbook of Chemistry, and the CRC Handbook of Chemistry and Physics. When a boiling point is given only at a different pressure, usually lower pressure than the normal pressure of 760 mm Hg, the boiling point at normal pressure can be approximately estimated by using boiling point-pressure nomographs, such as those given in “The Chemist's Companion,” A. J. Gordon and R. A. Ford, John Wiley & Sons Publishers, 1972, pp. 30-36.

Perfume raw materials having a B.P. lower than 250° C. and a C log P lower than 3.0 are called Quadrant I perfumes. Quadrant I perfumes having a B.P. lower than 250° C. and a C log P between 0 and 3.0 are preferred.

Perfume raw materials having a B.P. of about 250° C. or higher and a C log P lower than 3.0 are called Quadrant II perfumes. Quadrant II perfumes having a B.P. higher than 250° C. and a C log P between 0 and 3.0 are preferred.

Perfume raw materials having a B.P. less than 250° C. and a C log P higher than about 3.0 are called Quadrant III perfumes.

Perfume raw materials having a B.P. of about 250° C. or higher and a C log P of about 3.0 or higher are called Quadrant IV perfumes or enduring perfumes.

Traditionally, perfume accords are formulated around “enduring” perfumes (Quadrant IV) due to their high deposition efficiency hence odor impact on fabrics, while “non-enduring” perfumes, especially Quadrant I perfume ingredients, are considered difficult to deposit onto fabrics and as such typically are used solely in very low amount to minimize waste and pollution. Quadrant I perfume ingredients are hydrophilic (e.g., a C log P lower than 3.0) and have low boiling points (e.g., a B.P. lower than 250° C.); thus, they are easily lost to the wash or rinse medium or during heat drying. In compositions of the present disclosure, some non-enduring perfume ingredients, especially Quadrant I perfume ingredients, may be intentionally formulated, e.g., to improve the perfume odor in the headspace of the container to enable consumers to appreciate the perfume character upon opening the container. As described below, compositions of the present disclosure may include at least about 2%, or at least about 3%, or at least about 4%, by weight of the composition, of Quadrant I perfume ingredients.

Perfume according to the present disclosure may contain from about 15% to about 60%, preferably from about 20% to about 55%, more preferably from about 25% to about 50% by weight of the perfume accord of non-enduring perfume ingredients. Non-enduring perfume ingredients encompass Quadrant I, II and III perfume ingredients. Perfume according to the present disclosure may contain from about 2% to about 15%, preferably from about 3% to about 12%, more preferably from about 4% to about 10% by weight of the perfume of Quadrant I perfume ingredients. The perfume may include at least about 2%, or at least about 3%, or at least about 4%, by weight of the composition, of Quadrant I perfume ingredients. A certain minimum amount of Quadrant I perfume ingredients may be desirable to as to provide an immediate scent impression upon opening a container or use of the composition.

Additionally or alternatively, the perfume may include from about 2.5% to about 25%, preferably from about 3% to about 20%, more preferably from about 5% to about 15% of Quadrant II perfume ingredients, from about 10% to about 50%, preferably from about 15% to about 45%, more preferably from about 20% to about 40% of Quadrant III perfume ingredients, and/or from about 40% to about 85%, preferably from about 45% to about 75%, more preferably from about 40% to about 65% of Quadrant IV perfume ingredients.

Enzymes

The compositions described herein may comprise one or more enzymes which provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination is an enzyme cocktail that may comprise, for example, a protease and lipase in conjunction with amylase. When present in a detergent composition, the aforementioned additional enzymes may be present at levels from about 0.00001% to about 2%, from about 0.0001% to about 1% or even from about 0.001% to about 0.5% enzyme protein by weight of the composition. The compositions disclosed herein may comprise from about 0.001% to about 1% by weight of an enzyme (as an adjunct), which may be selected from the group consisting of lipase, amylase, protease, mannanase, cellulase, pectinase, and mixtures thereof.

The compositions may optionally comprise from about 0.001% to about 10%, or from about 0.005% to about 8%, or from about 0.01% to about 6%, by weight of the composition, of an enzyme stabilizing system. The enzyme stabilizing system can be any stabilizing system which is compatible with the detersive enzyme. Such a system may be inherently provided by other formulation actives, or be added separately, e.g., by the formulator or by a manufacturer of detergent-ready enzymes. Such stabilizing systems can, for example, comprise calcium ion, boric acid, propylene glycol, short chain carboxylic acids, boronic acids, chlorine bleach scavengers and mixtures thereof, and are designed to address different stabilization problems depending on the type and physical form of the detergent composition. In the case of aqueous detergent compositions comprising protease, a reversible protease inhibitor, such as a boron compound, including borate, 4-formyl phenylboronic acid, phenylboronic acid and derivatives thereof, or compounds such as calcium formate, sodium formate and 1,2-propane diol may be added to further improve stability.

Dyes and/or Fabric Hueing Agents

The composition may comprise a dye and/or a fabric hueing agent (sometimes referred to as shading, bluing or whitening agents).

The composition may comprise a dye, for example a non-substantive dye. Non-substantive dyes may be present in a composition provide desirable aesthetic qualities. A manufacturer may even formulate a dye into a composition to customize it in response to a consumer's request.

The composition may comprise a hueing agent. Typically the hueing agent provides a blue or violet shade to fabric. Hueing agents can be used either alone or in combination to create a specific shade of hueing and/or to shade different fabric types. This may be provided for example by mixing a red and green-blue dye to yield a blue or violet shade. Hueing agents may be selected from any known chemical class of dye, including but not limited to acridine, anthraquinone (including polycyclic quinones), azine, azo (e.g., monoazo, disazo, trisazo, tetrakisazo, polyazo), including premetallized azo, benzodifurane and benzodifuranone, carotenoid, coumarin, cyanine, diazahemicyanine, diphenylmethane, formazan, hemicyanine, indigoids, methane, naphthalimides, naphthoquinone, nitro and nitroso, oxazine, phthalocyanine, pyrazoles, stilbene, styryl, triarylmethane, triphenylmethane, xanthenes and mixtures thereof.

Suitable fabric hueing agents include dyes, dye-clay conjugates, and organic and inorganic pigments. Suitable dyes also include small molecule dyes and polymeric dyes. Suitable small molecule dyes include small molecule dyes selected from the group consisting of dyes falling into the Colour Index (C.I.) classifications of Direct, Basic, Reactive or hydrolysed Reactive, Solvent or Disperse dyes for example that are classified as Blue, Violet, Red, Green or Black, and provide the desired shade either alone or in combination. Suitable polymeric dyes include polymeric dyes selected from the group consisting of polymers containing covalently bound (sometimes referred to as conjugated) chromogens, (dye-polymer conjugates), for example polymers with chromogens co-polymerized into the backbone of the polymer and mixtures thereof. Suitable polymeric dyes also include polymeric dyes selected from the group consisting of fabric-substantive colorants sold under the name of Liquitint® (Milliken, Spartanburg, S.C., USA), dye-polymer conjugates formed from at least one reactive dye and a polymer selected from the group consisting of polymers comprising a moiety selected from the group consisting of a hydroxyl moiety, a primary amine moiety, a secondary amine moiety, a thiol moiety and mixtures thereof. Suitable polymeric dyes also include polymeric dyes selected from the group consisting of Liquitint® Violet CT, carboxymethyl cellulose (CMC) covalently bound to a reactive blue, reactive violet or reactive red dye such as CMC conjugated with C.I. Reactive Blue 19, sold by Megazyme, Wicklow, Ireland under the product name AZO-CM-CELLULOSE, product code S-ACMC, alkoxylated triphenyl-methane polymeric colourants, alkoxylated thiophene polymeric colourants, and mixtures thereof.

The aforementioned dyes and/or fabric hueing agents can be used in combination (any mixture of fabric hueing agents can be used).

Conditioning Agents

The composition of the present invention may include a high melting point fatty compound. The high melting point fatty compound useful herein has a melting point of 25° C. or higher, and is selected from the group consisting of fatty alcohols, fatty acids, fatty alcohol derivatives, fatty acid derivatives, and mixtures thereof. Such compounds of low melting point are not intended to be included in this section. The high melting point fatty compound is included in the composition at a level of from about 0.1% to about 40%, preferably from about 1% to about 30%, more preferably from about 1.5% to about 16% by weight of the composition, from about 1.5% to about 8%.

The composition of the present invention may include a nonionic polymer as a conditioning agent.

Suitable conditioning agents for use in the composition include those conditioning agents characterized generally as silicones (e.g., silicone oils, cationic silicones, silicone gums, high refractive silicones, and silicone resins), organic conditioning oils (e.g., hydrocarbon oils, polyolefins, and fatty esters) or combinations thereof, or those conditioning agents which otherwise form liquid, dispersed particles in the aqueous surfactant matrix herein. The concentration of the silicone conditioning agent typically ranges from about 0.01% to about 10%.

The compositions of the present invention may also comprise from about 0.05% to about 3% of at least one organic conditioning oil as the conditioning agent, either alone or in combination with other conditioning agents, such as the silicones (described herein). Suitable conditioning oils include hydrocarbon oils, polyolefins, and fatty esters.

Fabric Enhancement Polymers

Suitable fabric enhancement polymers are typically cationically charged and/or have a high molecular weight. Suitable concentrations of this component are in the range from 0.01% to 50%, preferably from 0.1% to 15%, more preferably from 0.2% to 5.0%, and most preferably from 0.5% to 3.0% by weight of the composition. The fabric enhancement polymers may be a homopolymer or be formed from two or more types of monomers. The fabric enhancement polymer may be a polysaccharide, or a cationic polysaccharide, or a cationic cellulose derivative, such as cationic modified hydroxyethyl cellulose. The monomer weight of the polymer will generally be between 5,000 and 10,000,000, typically at least 10,000 and preferably in the range 100,000 to 2,000,000. Preferred fabric enhancement polymers will have cationic charge densities of at least 0.2 meq/gm, preferably at least 0.25 meq/gm, more preferably at least 0.3 meq/gm, but also preferably less than 5 meq/gm, more preferably less than 3 meq/gm, and most preferably less than 2 meq/gm at the pH of intended use of the composition, which pH will generally range from pH 3 to pH 9, preferably between pH 4 and pH 8. The fabric enhancement polymers may be of natural or synthetic origin. The fabric enhancement polymer may be any suitable Polyquaternium polymer, e.g., Polyquaternium 1-47.

Pearlescent Agent

The laundry detergent compositions of the invention may comprise a pearlescent agent. Non-limiting examples of pearlescent agents include: mica; titanium dioxide coated mica; bismuth oxychloride; fish scales; mono and diesters of alkylene glycol; or mixtures thereof. The pearlescent agent may be ethyleneglycoldistearate (EGDS).

Opacifier

The compositions of the present disclosure may include an opacifier. The opacifier may be selected from the group consisting of styrene/acrylate latexes, titanium dioxide, Tin dioxide, any forms of modified TiO₂, for example carbon modified TiO₂ or metallic doped (e.g. Platinum, Rhodium) TiO₂ or stannic oxide, bismuth oxychloride or bismuth oxychloride coated TiO₂/Mica, silica coated TiO₂ or metal oxide coated and mixtures thereof. In some examples, styrene/acrylate latexes available from the Rohm & Haas Company and sold under the trademark Acusol are used. The latexes may be characterized by pH of about 2 to about 3, having approximately 40% solids in water, with a particle size of about 0.1 to about 0.5 micron. In other examples, Acusol® polymers may be used and include Acusol® OP301 (styrene/acrylate) polymer, Acusol® OP302, (Styrene/Acrylate/Divinylbenzene Copolymer), Acusol® OP303 (Styrene/Acrylamide Copolymer), Acusol® OP305 (Styrene/PEG-10 Maleate/Nonoxynol-10 Maleate/Acrylate Copolymer) and (Styrene/Acrylate/PEG-10 Dimaleate Copolymer) and mixtures thereof. The polymers may have a molecular weight of from 1,000 to 1,000,000, in some examples from 2,000 to 500,000, and in further examples from 5,000 to 20,000.

The opacifier may be present in an amount sufficient to leave the liquid detergent product, in which it is incorporated, white. Where the opacifier is an inorganic opacifier (e.g. TiO₂, or modifications thereof), the opacifier may be present at a level of from 0.001% to 1%, in some examples from 0.01% to 0.5%, and in further examples from 0.05% to 0.15% by weight of the liquid detergent product. Where the opacifier is an organic opacifier (e.g. styrene/acrylate latexes), the opacifier may be present at a level of from 0.001% to 2.5%, in some examples from 1% to 2.2%, and in further examples from 1.4% to 1.8% by weight of the liquid detergent product.

Structurant/Thickeners

The compositions of the present disclosure may include a structurant or thickener. Such materials are useful for providing stability, rheology, and/or suspension capability benefits to a composition. Structuring agents may be added as a lone ingredient or as part of a premix.

Suitable structurants/thickeners include non-polymeric crystalline hydroxyl-functional materials. The composition may comprise from about 0.01 to about 1% by weight of the composition of a non-polymeric crystalline, hydroxyl functional structurant. The non-polymeric crystalline, hydroxyl functional structurants generally may comprise a crystallizable glyceride which can be pre-emulsified to aid dispersion into the final fluid detergent composition. The crystallizable glycerides may include hydrogenated castor oil or “HCO” or derivatives thereof, provided that it is capable of crystallizing in the liquid detergent composition.

Suitable structurants/thickeners include di-benzylidene polyol acetal derivative. The fluid detergent composition may comprise from about 0.01% to about 1% by weight of a dibenzylidene polyol acetal derivative (DBPA), or from about 0.05% to about 0.8%, or from about 0.1% to about 0.6%, or even from about 0.3% to about 0.5%. The DBPA derivative may comprise a dibenzylidene sorbitol acetal derivative (DBS).

Suitable structurants/thickeners also include bacterial cellulose. The fluid detergent composition may comprise from about 0.005% to about 1% by weight of a bacterial cellulose network. The term “bacterial cellulose” encompasses any type of cellulose produced via fermentation of a bacteria of the genus Acetobacter such as CELLULON® by CPKelco U.S. and includes materials referred to popularly as microfibrillated cellulose, reticulated bacterial cellulose, and the like.

Suitable structurants/thickeners also include coated bacterial cellulose. The bacterial cellulose may be at least partially coated with a polymeric thickener. The at least partially coated bacterial cellulose may comprise from about 0.1% to about 5%, or even from about 0.5% to about 3%, by weight of bacterial cellulose; and from about 10% to about 90% by weight of the polymeric thickener. Suitable bacterial cellulose may include the bacterial cellulose described above and suitable polymeric thickeners include: carboxymethylcellulose, cationic hydroxymethylcellulose, and mixtures thereof.

Suitable structurants/thickeners also include cellulose fibers. The composition may comprise from about 0.01 to about 5% by weight of the composition of a cellulosic fiber. The cellulosic fiber may be extracted from vegetables, fruits or wood. Commercially available examples are Avicel® from FMC, Citri-Fi from Fiberstar or Betafib from Cosun.

Suitable structurants/thickeners also include polymeric structuring agents. The compositions may comprise from about 0.01% to about 5% by weight of a naturally derived and/or synthetic polymeric structurant. Examples of naturally derived polymeric structurants of use in the present invention include: hydroxyethyl cellulose, hydrophobically modified hydroxyethyl cellulose, carboxymethyl cellulose, polysaccharide derivatives and mixtures thereof. Suitable polysaccharide derivatives include: pectine, alginate, arabinogalactan (gum Arabic), carrageenan, gellan gum, xanthan gum, guar gum and mixtures thereof. Examples of synthetic polymeric structurants of use in the present invention include: polycarboxylates, polyacrylates, hydrophobically modified ethoxylated urethanes, hydrophobically modified nonionic polyols and mixtures thereof.

Suitable structurants/thickeners also include di-amido-gellants. The external structuring system may comprise a di-amido gellant having a molecular weight from about 150 g/mol to about 1,500 g/mol, or even from about 500 g/mol to about 900 g/mol. Such di-amido gellants may comprise at least two nitrogen atoms, wherein at least two of said nitrogen atoms form amido functional substitution groups. The amido groups may be different or the same. Non-limiting examples of di-amido gellants are: N,N′-(2S,2′S)-1,1′-(dodecane-1,12-diylbis(azanediyl))bis(3-methyl-1-oxobutane-2,1-diyl)diisonicotinamide; dibenzyl (2S,2′S)-1,1′-(propane-1,3-diylbis(azanediyl))bis(3-methyl-1-oxobutane-2,1-diyl)dicarbamate; dibenzyl (2S,2′S)-1,1′-(dodecane-1,12-diylbis(azanediyl))bis(1-oxo-3-phenylpropane-2,1-diyl)dicarbamate.

Water

The compositions disclosed herein may comprise from about 1% to about 80%, by weight of the composition, water. Water may act as a carrier ingredient of the compositions of the present disclosure. When the composition is a heavy duty liquid detergent composition, the composition typically comprises from about 40% to about 80% water. When the composition is a compact liquid detergent, the composition typically comprises from about 20% to about 60%, or from about 30% to about 50% water. When the composition is in unit dose form, for example, encapsulated in water-soluble film, the composition typically comprises less than 20%, or less than 15%, or less than 12%, or less than 10%, or less than 8%, or less than 5% water. The composition may comprise from about 1% to 20%, or from about 3% to about 15%, or from about 5% to about 12%, by weight of the composition, water. When the composition is in unitized dose form, for example, encapsulated in water-soluble film, the composition typically comprises less than 20%, or less than 15%, or less than 12%, or less than 10%, or less than 8%, or less than 5% water. The composition may comprise from about 1% to 20%, or from about 3% to about 15%, or from about 5% to about 12%, by weight of the composition, water.

Other carriers may include organic solvents, such as non-aminofunctional solvents.

Container

The compositions of the present disclosure may be provided in a container. The composition of the present disclosure may be packaged compositions, meaning that the composition is contained in container suitable for sale or other distribution to a user for consumer or industrial use. The containers are typically closed containers that may be opened by the user to dispense and subsequently use the composition contained therein.

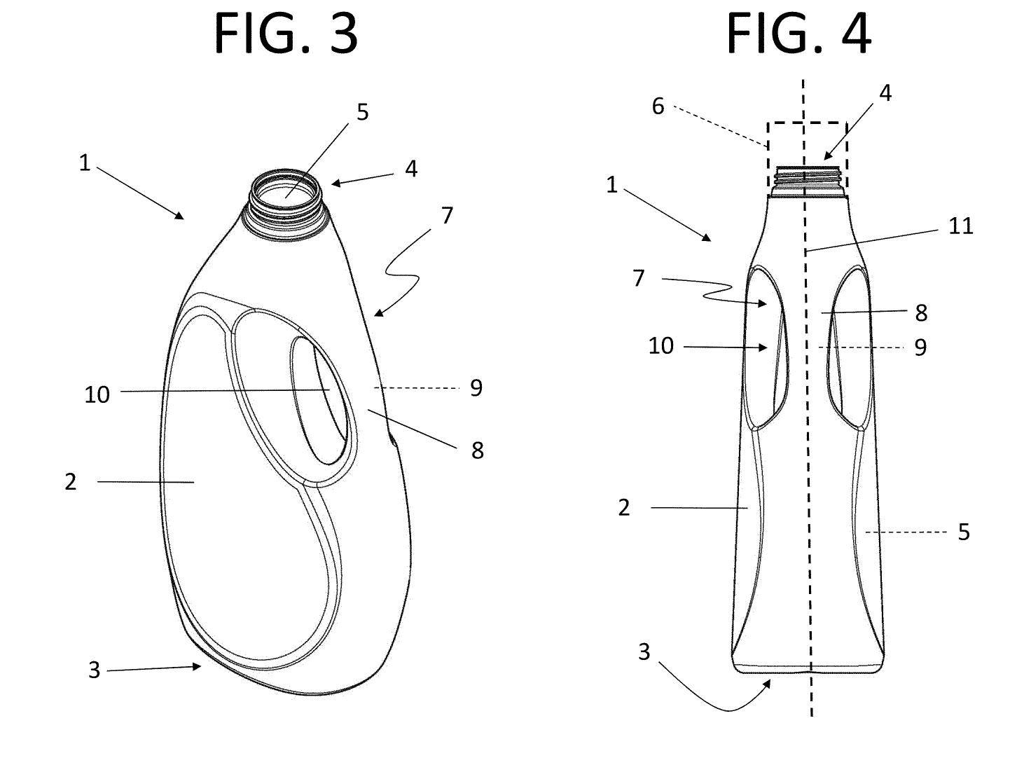

FIG. 3 shows a perspective view of a representative container 1 according to the present disclosure. The container 1 may include walls 2 that define a closed end 3, an open end 4, and an interior volume 5. The open end 4 may be closeable, preferably selectively recloseable, for example with a cap 6. The cap 6 may be selectively removeable from the open end of the container and may attach to the container by a snap bead or thread system. Any suitable material may be selected as the material of the container, including polypropylene and/or or polyethylene terephthalate. The container 1 may be opaque or translucent. The methods of the present disclosure, which include dispensing the contained composition from the container 1, are particularly well suited for non-transparent containers, as attempting to analyze the composition in the container using image analysis and/or spectrographic methods are unlikely to be successful.

The compositions may be contained in the interior volume 5 of the container and dispensed through the open end 4 of the container 1.

The container 1 may comprise a handle 7. The handle 7 may be a hollow handle 8 comprising an interior space 9 in fluid communication with the interior volume 5 of the container 1. The composition may flow through the interior space of the hollow handle. It is believed that such a configuration will facilitate mixing of the composition during normal usage.

The container 1 may be in the form of a bottle. The bottle may comprise a handle 7. The handle 7 may at least partially be formed by a throughhole 10 in the container 1. The handle 7 may be a hollow handle 8.

The container 1 may be an asymmetrical container being characterized by having no more than two planes of symmetry, preferably by no more than one plane of symmetry. FIG. 4 shows a side view of a representative container 1 in the form of a bottle having only one plane of symmetry 11. It may be preferred that the container 1 is not a rectangular prism (e.g., a box) or a cylinder (e.g., a pail), as such symmetrical containers may not fully facilitate mixing upon normal usage.

The container 1 may include interior baffles. Interior baffles project inwardly towards the interior volume of the container and may facilitate turbulence in, and thus mixing of, the composition, upon normal usage of the product.

The container may be in the form of a flexible bag. Such bags may have selectively openable spouts through which the composition may be dispensed. Such bags may include containers intended for one use only; in such bags, a portion of the bag may be removeable, such as by tearing the portion off, preferably at an area or line of weakness.

Methods of Making

The present disclosure also relates to methods of the compositions described herein. Compositions of the present disclosure may be made by combining the ingredients in any suitable manner Certain ingredients may be added sequentially, in a continuous loop processes, or in a batch process.

Because the compositions of the present disclosure are typically non-homogeneous, it may be desirable to minimize mixing processes, at least with regard to the final product. Certain portions, such as base compositions and/or premixes, may be well-mixed, but mixing processes after additional adjuncts are added may be limited. Thus, the methods of the present disclosure may relate to providing a base composition, and adding an adjunct ingredient to the base composition.

Mixing energy provided by the manufacturer to the final composition may be limited. For example, after the adjunct is added to the base composition, it may be that no more than 15 J/kg of product, or no more than about 10 J/kg of product, or no more than about 5 J/kg of product, or no more than about 2 J/kg of product, of mixing energy is provided to the final composition by the manufacturer.

The final composition may be provided in a container, such as a bottle. The container, e.g., a bottle, may be an asymmetrical container, meaning that the container includes no more than two, preferably no more than one, plane of symmetry. The container may be a handled bottle, preferably with a hollow handle comprising an interior space in fluid communication with the interior volume of the bottle and through which the composition may flow. The container may include interior baffles, which may contribute to mixing the composition after the final product leaves the manufacturing/packaging site.

The method of making may include providing a base composition and adding an adjunct to the base composition to make the final product. The base composition may be provided in a container, and the adjunct may be added directly to the container. The adjunct may be combined with the base composition nearly immediately prior to being provided to a container, such as less than 10 seconds prior, or less than 5 seconds prior, or less than 2 seconds prior, or less than 1 second prior. Such combining may occur in a vessel having one or more input openings and one output opening. The vessel may be a nozzle.

The compositions of the present disclosure may be made according to a customer's or consumer's own preference, which may be communicated to the manufacturer by physical or electronic communication, such as by placing an order over the internet. Thus, the methods of making compositions according to the present disclosure may comprise the step of receiving input signals; the input signals originate from a remote location. The input signals may be physical, for example an invoice or purchase order written on paper and sent through postal mail. The input signals may be electronic, such as by placing an order over the internet, via text message, by pressing buttons or screen icons at an in-store kiosk or display, or by any other suitable mode of electronic communication. The input signals may even be verbal, such as an order placed over the telephone or face-to-face. The input signals may include the type of adjunct(s) desired in the composition, and/or may specify particular characteristics or identity of the adjunct, such as perfume type, which may be selected from a menu.

### Methods of Using

The present disclosure relates to methods of treating a surface with the compositions disclosed herein. The method may include contacting a surface with the compositions of the present disclosure.

The present invention includes methods for cleaning soiled material. Compact fluid detergent compositions that are suitable for sale to consumers are suited for use in laundry pretreatment applications, laundry cleaning applications, and home care applications.

Such methods include, but are not limited to, the steps of contacting detergent compositions in neat form or diluted in wash liquor, with at least a portion of a soiled material and then optionally rinsing the soiled material. The soiled material may be subjected to a washing step prior to the optional rinsing step.

For use in laundry pretreatment applications, the method may include contacting the detergent compositions described herein with soiled fabric. Following pretreatment, the soiled fabric may be laundered in a washing machine or otherwise rinsed.

Machine laundry methods may comprise treating soiled laundry with an aqueous wash solution in a washing machine having dissolved or dispensed therein an effective amount of a machine laundry detergent composition in accord with the invention. An “effective amount” of the detergent composition means from about 20 g to about 300 g of product dissolved or dispersed in a wash solution of volume from about 5 L to about 65 L. The water temperatures may range from about 5° C. to about 100° C. The water to soiled material (e.g., fabric) ratio may be from about 1:1 to about 30:1. The compositions may be employed at concentrations of from about 500 ppm to about 15,000 ppm in solution. In the context of a fabric laundry composition, usage levels may also vary depending not only on the type and severity of the soils and stains, but also on the wash water temperature, the volume of wash water, and the type of washing machine (e.g., top-loading, front-loading, top-loading, vertical-axis Japanese-type automatic washing machine).

The detergent compositions herein may be used for laundering of fabrics at reduced wash temperatures. These methods of laundering fabric comprise the steps of delivering a laundry detergent composition to water to form a wash liquor and adding a laundering fabric to said wash liquor, wherein the wash liquor has a temperature of from about 0° C. to about 20° C., or from about 0° C. to about 15° C., or from about 0° C. to about 9° C. The fabric may be contacted to the water prior to, or after, or simultaneous with, contacting the laundry detergent composition with water.

Another method includes contacting a nonwoven substrate, which is impregnated with the detergent composition, with a soiled material. As used herein, “nonwoven substrate” can comprise any conventionally fashioned nonwoven sheet or web having suitable basis weight, caliper (thickness), absorbency, and strength characteristics. Non-limiting examples of suitable commercially available nonwoven substrates include those marketed under the tradenames SONTARA® by DuPont and POLYWEB® by James River Corp.

Hand washing/soak methods, and combined handwashing with semi-automatic washing machines, are also included.

For use in dishwashing applications, the method may include contacting the detergent compositions described herein with soiled dishware. The contacting step may take place in the presence of water. The method may include a washing step and/or a rinsing step. The washing step may occur by hand, and/or may occur in an automatic dishwashing machine.

### Combinations

Specifically contemplated combinations of the disclosure are herein described in the following lettered paragraphs. These combinations are intended to be illustrative in nature and are not intended to be limiting.

A. A packaged, non-homogeneous liquid composition, the composition residing in a container, the composition being a single phase liquid composition, the composition comprising water and an adjunct selected from encapsulates, neat perfume, enzymes, fabric hueing agents, conditioning agents, fabric enhancement polymers, pearlescent agents, opacifiers, or mixtures thereof, wherein when the composition is divided into Large Samples according to the method described herein (Preparation of Large Samples), the first about 10% of the Large Samples comprise a first average adjunct concentration (Direct or Calculated) of the adjunct, and the last about 10% of the Large Samples comprise a second average adjunct concentration (Direct or Calculated, determined the same manner as the first average adjunct concentration) of the adjunct, wherein either: a) the first average adjunct concentration is at least about 1% greater than the second average adjunct concentration; or b) the first average adjunct concentration is at least about 1% less than the second average adjunct concentration.

B. The liquid composition according to paragraph A, wherein the first average adjunct concentration is at least about 1% greater, preferably at least about 3% greater, more preferably at least about 5% greater, even more preferably at least about 7% greater than the second average adjunct concentration.

C. The liquid composition according to paragraph A, wherein the first average adjunct concentration is at least about 1% less, preferably at least about 3% less, more preferably at least about 5% less, even more preferably at least about 7% less than the second average adjunct concentration.

D. The liquid composition according to any of paragraphs A-C, wherein the first average adjunct concentration is not more than 25% greater or not more than 25% less than the second average adjunct concentration.

E. A liquid composition, the liquid composition being disposed in a container, the liquid composition being a single phase liquid composition, the liquid composition comprising an adjunct ingredient, wherein when the composition is divided into Large Samples according to the method provided herein, the weighted mean adjunct concentration of the first 10% of Large Samples is at least 1%, or at least 2%, or at least 3%, or at least 5%, or at least 7.5%, or at least 10%, different from the mean adjunct concentration of all of the Large Samples.

F. A liquid composition according to any of paragraphs A-E, wherein the weighted mean adjunct concentration of the first 10% of Large Samples is at least 1%, or at least 2%, or at least 3%, or at least 5%, or at least 7.5%, or at least 10%, greater than the mean adjunct concentration of all of the Large Samples.

G. A liquid composition according to any of paragraphs A-F, wherein the weighted mean adjunct concentration of the first 10% of Large Samples is at least 1%, or at least 2%, or at least 3%, or at least 5%, or at least 7.5%, or at least 10%, less than the mean adjunct concentration of all of the Large Samples.

H. A liquid composition, the liquid composition being disposed in a container, the liquid composition being a single phase liquid composition, the liquid composition comprising an adjunct ingredient, wherein the liquid composition is characterized by an Adjunct Variation Index, as determined according to the method provided herein, of equal to or less than 1.0, or equal to or less than 0.75, or equal to or less than 0.6, or equal to or less than 0.5, or equal to or less than 0.4, or equal to or less than 0.3, or equal to or less than 0.25, and preferably at least equal to or greater than 0.1.

I. The liquid composition according to any of paragraphs A-H, wherein the adjunct is neat perfume, encapsulates, dye, a hueing agent, a conditioning agent, a fabric enhancement polymer, or a mixture thereof, preferably neat perfume, encapsulates, or a mixture thereof, even more preferably neat perfume.

J. The liquid composition according to any of paragraphs A-I, wherein the adjunct is neat perfume that comprises from about 2% to about 15%, by weight of the neat perfume, of Quadrant I perfume ingredients having a boiling point lower than 250° C. and a C log P lower than 3.

K. The liquid composition according to any of paragraphs A-J, wherein the adjunct ingredient is enzymes.

L. The liquid composition according to any of paragraphs A-K, wherein the adjunct ingredient is dye, a hueing agent, or a mixture thereof, preferably a hueing agent.

M. The liquid composition according to any of paragraphs A-L, wherein the composition comprises from about 0.0001% to about 10%, by weight of the composition, of the adjunct ingredient.

N. The liquid composition according to any of paragraphs A-M, wherein the composition further comprises a surfactant selected from the group consisting of anionic surfactants, nonionic surfactants, cationic surfactants, zwitterionic surfactants, amphoteric surfactants, ampholytic surfactants, and mixtures thereof.

O. The liquid composition according to any of paragraphs A-N, wherein the surfactant comprises from about 1% to about 70%, preferably from about 5% to about 50%, more preferably from about 5% to about 25%, by weight of the composition, of anionic surfactant.

P. The liquid composition according to any of paragraphs A-O, wherein the composition further comprises a structurant, preferably a structurant that comprises non-polymeric crystalline hydroxyl-functional materials, more preferably a structurant that comprises hydrogenated castor oil.

Q. The liquid composition according to any of paragraphs A-P, wherein the Relative Standard Deviation of the Large Samples (RSD-L) is greater than the known or determined Relative Standard Deviation of the method used to determine the adjunct concentration (RSD-method).

R. The liquid composition according to any of paragraphs A-Q, wherein the liquid composition is characterized by an Adjunct Variation Index, as determined according to the method provided herein, of equal to or less than 1.0, or equal to or less than 0.75, or equal to or less than 0.6, or equal to or less than 0.5, or equal to or less than 0.4, or equal to or less than 0.3, or equal to or less than 0.25, and preferably at least equal to or greater than 0.1.

S. The liquid composition according to any of paragraphs A-R, wherein the composition is a consumer product composition, preferably selected from the group consisting of fabric care compositions, hard surface cleaning compositions, dishwashing compositions, air care compositions, hair care compositions, and mixtures thereof.

T. The liquid composition according to any of paragraphs A-S, wherein the container is a bottle comprising a handle, preferably a hollow handle comprising an interior space in fluid communication with the interior volume of the bottle, where the composition may flow through the interior space of the hollow handle.

U. The liquid composition of according to any of paragraphs A-T, wherein the composition is made by providing a base composition, and adding the adjunct ingredient to the base composition to form the non-homogeneous composition.

V. The liquid composition according to any of paragraphs A-U, wherein the base composition is provided in the container.

W. The liquid composition according to any of paragraphs A-V, wherein the liquid composition is phase stable upon storage for 14 days at 20° C., preferably at 10° C.

X. The liquid composition according to any of paragraphs A-W, wherein the container is an opaque container.

Y. The liquid composition according to any of paragraphs A-X, wherein the liquid composition is characterized by a viscosity in the range of from about 200 to about 1000 mPa*s at 25° C. at a shear rate of 20 sec-¹.

Z. A method of treating a surface, the method comprising the step of contacting a surface, preferably a fabric, with the composition according to any of paragraphs A-W.

### Test Methods and Calculations

### I. Sample Preparation

The objective of this method is to divide the package into equal samples without imparting significant turbulence and mixing to the composition in the package. Said series of samples will be largely representative of product in different regions of the package progressing from the outlet to the opposite end of the package. In sum, as shown in the schematic diagram of FIG. 1, the composition 12 in the original container 1 is divided into “large samples,” 20, 21 which each may then be sub-divided into populations 22, 23 or pluralities of “small samples” 24, 25.

A. Preparation of Large Samples

Prior to preparing the Large Samples as described below, the package should be stored at room temperature (20° C.+/−2° C.) for 24 hours to allow for natural de-aeration and/or other settling of the product.

1. For Packages Intended to Tip and Pour Out Product

Most packages will have a preferred method of dispensing the product noted on the manufacturer's instructions and/or dictated by the design of the package. For example, there is often a pour spout in the opening and either a handle or a recess on the package suitable for gripping. In this case, the package should be poured out as noted by the manufacturer according to the guidelines of flow rate and sample containers noted below. If there are not explicit directions, then the following guidelines should be followed.

a) The package should be tilted and poured in the direction of a non-symmetrical (directional) pour spout or an opening located anywhere other than the geometrical center of the top of the package.

b) In the event of a symmetrical pour spout or package with an opening but no pour spout, the package should be tilted and poured directly opposite the handle or grip region of the package.

c) In the event of a symmetrical pour spout or with an opening but no pour spout but without a handle or grip location, tilting of the package should be by varying the angle between the major axis of the cross section of the package bottom and the vertical axis of the package.

d) In the event of a completely symmetrical pour spout, opening and package, in a direction of the user's choice.

The package should be poured into convenient, closable containers (e.g., Qorpak GLC-01624 available from VWR) capable of easily pouring out the contents and holding the minimum recommended dose of product with suitable excess volume to enable accurate pouring without spillage. A plurality of sample containers sufficient to hold the entire volume of the package should be sequentially numbered and set up in an array that facilities filling all the containers in sequence without returning the package to the resting, vertical position. The containers should be numbered or otherwise marked in order to track the sequential pours (e.g., the first pour is Large Sample 1, the second is Large Sample 2, etc.).

Pouring should be consistent with good laboratory practices suitable to decant a supernatant liquid from a heterogeneous mixture in a container. Gently lift and move the package above the sample containers and pour at the minimum angle necessary to achieve a gentle flow at about 1-5 mL/second. The rate can be assessed and controlled by having the containers located on a laboratory scale while pouring and/or timing the fill to a known volume.

After filling each container, gently reduce the angle of the package to just stop the flow of product, reposition the package to be over the next sample container, and gently increase the angle to resume the gentle flow. Repeat until the package is empty. Each container now contains a Large Sample.

It is preferred that the composition contained in the package is divided into at least 25, preferably at least 30 Large Samples to provide a statistically significant number of samples. For consumer products such as laundry detergent, it is desired that the amount or volume of composition in each Large Sample is at least as much as the manufacturer's minimum recommended dose, so that the Large Samples each contain a consumer-relevant amount of the composition. Thus, larger container sizes are preferred (e.g., approx. 1.5 L or more) so as to provide a sufficient number of Large Samples, where each Large Sample has a sufficient (consumer-relevant) amount of composition. For example, a 1.47 L bottle of liquid TIDE® may be divided into 32 Large Samples, each of which includes approx. 45 mL of the detergent composition.

The amounts (e.g., volume or mass) of the Large Samples derived from a given composition should be approximately the same, i.e., +/−5% of each other.

2. For Other Packages

Most packages will have a preferred method of dispensing the product noted on the manufacturer's instructions and/or dictated by the ergonomics of the package. For example, there may be a recloseable valve that is open from the force of the product when the package is squeezed often used on more viscous products or there may be a tap with a valve the consumer can open to begin the flow of the product.

The package should be dispensed according to the manufacturer's recommendations with the following guidelines: The package should be dispensed into convenient, closable containers (e.g., Qorpak GLC-01624 available from VWR) capable of easily pouring out the contents and holding a recommended dose of product with suitable excess volume to enable accurate pouring without spillage. A plurality of sample containers sufficient to hold the entire volume of the package should be numbered and set up in an array that facilities filling all the containers in sequence without returning the product package to the resting, vertical position. Dispensing should be consistent with good laboratory practices suitable to decant a subnatant liquid from a heterogeneous mixture in a package. Gently lift and move the package above the sample containers and dispense with a gentle flow of about 1-5 ml/second. The rate can be assessed and controlled by having the containers located on a laboratory scale while pouring and/or timing the fill to a known volume. If it is not possible to adjust the rate from the package, allow the product to dispense at the design rate. After filling each container, stop the flow of product, gently reposition the package to be over the next sample container, gently resume the flow. Repeat until the package is empty.

If the package contains a plurality of soluble unit dose articles, each article is already considered a Large Sample. While wearing appropriate eye and skin protection, the experimenter carefully punctures each article (including each compartment, if multiple compartments are present), and the contents of each article are dispensed into a different container as described above.

B. Preparation of Small Samples

The compositions of the Large Samples should be subdivided by pouring into convenient, closable small containers (e.g., Wheaton 986546 available from VWR (66021-533)) capable of easily pouring out the contents and holding at least 1-2 ml of product with suitable excess volume to enable accurate pouring without spillage. A plurality of sample containers sufficient to hold the entire volume of the large sample container should be numbered and set up in an array that facilities filling all the containers in sequence without returning the large sample container to the resting, vertical position. Pouring should be consistent with good laboratory practices suitable to decant a supernatant liquid from a hetergeneous mixture in a container. Gently lift and move the large sample container above the sample containers and pour at the minimum angle necessary to achieve a gentle flow at about 1-2 ml/second. The rate can be assessed and controlled by having the containers located on a laboratory scale while pouring and/or timing the fill to a known volume. After filling each container, gently reduce the angle of the large sample container to just stop the flow of product, reposition the package to be over the next small sample container, gently increase the angle to resume the gentle flow. Repeat until the large sample container is empty.

The amounts (e.g., volume or mass) of the Small Samples derived from a given Large Sample should be approximately the same, i.e., +/−5% of each other.

### II. Determination of Adjunct Concentration

For a given adjunct, the concentration of the given adjunct in the Large Samples and/or the Small Samples may be determined.

Prior to concentration analysis, the sample (Large Sample or Small Sample; not the entire composition as packaged) is homogenized by shaking or vigorous stirring.

For each Large or Small Sample, the concentration of the given adjunct should be determined by a suitable method. For a given adjunct, one or ordinary skill will be able to select a suitable method. If known, the validated relative standard deviation resulting from the particular method (“RSD-method”) for a well-mixed/homogeneous product should be noted for subsequent calculations.

If the given adjunct is selected from neat perfume (even if added to, or present in, the composition as a premix and/or emulsion), delivery particles (e.g, perfume encapsulates), dye (including hueing dye), or protease/amylase enzymes, the following methods, respectively, are used to determine the concentration of the given adjunct, if appropriate. (For example, it is recognized that Absorbance may not be a suitable method if the composition comprises, for example, opacifier.) It is understood that the concentrations may be provided as direct measurements (e.g., weight percent or moles per gram), or as indirect measurements (absorbance or activity level).

A. Neat Perfume—Headspace Analysis

Neat product headspace analysis is performed using Solid Phase Microextraction Gas Chromatography Mass Spectrometry (SPME GC-MS). The SPME technique utilizes a fiber coated with 50/30 μm divinylbenzene/Carboxen on polydimethylsiloxane on a StableFlex fiber that adsorb analytes from the headspace. 1 gram of each sample tested is weighed into a 20 mL headspace vial and capped. Samples are equilibrated at 45 C for 30 minutes prior to a 5 minute extraction. Perfume analytes are desorbed from the fiber by exposing the fiber in the injection port of the GC at 270 C. The split ratio (split vent flow rate/column flow rate) in the inlet is 150:1 or 250:1. Perfume signal increases as the concentration in the headspace increases within the linear range of method.

The method is known to have a relative standard deviation (RSD-method) of 4.6%.

B. Delivery Particles (e.g., Perfume Encapsulates)

Except where otherwise specified herein, the preferred method to isolate benefit agent containing delivery particles from finished products is based on the fact that the density of most such particles is different from that of water. The finished product is mixed with water in order to dilute and/or release the particles. The diluted product suspension is centrifuged to speed up the separation of the particles. Such particles tend to float or sink in the diluted solution/dispersion of the finished product. Using a pipette or spatula, the top and bottom layers of this suspension are removed, and undergo further rounds of dilution and centrifugation to separate and enrich the particles. The particles are observed using an optical microscope equipped with crossed-polarized filters or differential interference contrast (DIC), at total magnifications of 100× and 400×. The microscopic observations provide an initial indication of the presence, size, quality and aggregation of the delivery particles.

For extraction of delivery particles from a liquid fabric enhancer finished product conduct the following procedure:

1. Place three aliquots of approximately 20 ml of liquid fabric enhancer into three separate 50 ml centrifuge tubes and dilute each aliquot 1:1 with DI water (eg 20 ml fabric enhancer+20 ml DI water), mix each aliquot well and centrifuge each aliquot for 30 minutes at approximately 10000×g.

2. After centrifuging per Step 1, discard the bottom water layer (around 10 ml) in each 50 ml centrifuge tube then add 10 ml of DI water to each 50 ml centrifuge tube.

3. For each aliquot, repeat the process of centrifuging, removing the bottom water layer and then adding 10 ml of DI water to each 50 ml centrifuge tube two additional times.

4. Remove the top layer with a spatula or a pipette.

5. Transfer this top layer into a 1.8 ml centrifuge tube and centrifuge for 5 minutes at approximately 20000×g.

6. Remove the top layer with a spatula and transfer into a new 1.8 ml centrifuge tube and add DI water until the tube is completely filled, then centrifuge for 5 minutes at approximately 20000×g.

7. Remove the bottom layer with a fine pipette and add DI water until tube is completely filled and centrifuge for 5 minutes at approximately 20000×g.

8. Repeat step 7 for an additional 5 times (6 times in total).

If both a top layer and a bottom layer of enriched particles appear in the above described step 1, then, immediately move to step 3 (i.e., omit step 2) and proceed steps with steps 4 through 8. Once those steps have been completed, also remove the bottom layer from the 50 ml centrifuge tube from step 1, using a spatula or/and a pipette. Transfer the bottom layer into a 1.8 ml centrifuge tube and centrifuge 5 min at approximately 20000×g. Remove the bottom layer in a new tube and add DI water until the tube is completely filled then centrifuge for 5 minutes approximately 20000×g. Remove the top layer (water) and add DI water again until the tube is full. Repeat this another 5 times (6 times in total). Recombine the particle enriched and isolated top and bottom layers back together.

If the fabric enhancer has a white color or is difficult to distinguish the particle enriched layers add 4 drops of dye (such as Liquitint Blue JH 5% premix from Milliken & Company, Spartanburg, S.C., USA) into the centrifuge tube of step 1 and proceed with the isolation as described.

For extraction of delivery particles from solid finished products which disperse readily in water, mix 1 L of DI water with 20 g of the finished product (eg. detergent foams, films, gels and granules; or water-soluble polymers; soap flakes and soap bars; and other readily water-soluble matrices such as salts, sugars, clays, and starches). When extracting particles from finished products which do not disperse readily in water, such as waxes, dryer sheets, dryer bars, and greasy materials, it may be necessary to add detergents, agitation, and/or gently heat the product and diluent in order to release the particles from the matrix. The use of organic solvents or drying out of the particles should be avoided during the extraction steps as these actions may damage the delivery particles during this phase.

For extraction of delivery particles from liquid finished products which are not fabric softeners or fabric enhancers (eg., liquid laundry detergents, liquid dish washing detergents, liquid hand soaps, lotions, shampoos, conditioners, and hair dyes), mix 20 ml of finished product with 20 ml of DI water. If necessary, NaCl (eg., 100-200 g NaCl) can be added to the diluted suspension in order to increase the density of the solution and facilitate the particles floating to the top layer. If the product has a white color which makes it difficult to distinguish the layers of particles formed during centrifugation, a water-soluble dye can be added to the diluent to provide visual contrast.

The water and product mixture is subjected to sequential rounds of centrifugation, involving removal of the top and bottom layers, re-suspension of those layers in new diluent, followed by further centrifugation, isolation and re-suspension. Each round of centrifugation occurs in tubes of 1.5 to 50 ml in volume, using centrifugal forces of up to 20,000×g, for periods of 5 to 30 minutes. At least six rounds of centrifugation are typically needed to extract and clean sufficient particles for testing. For example, the initial round of centrifugation may be conducted in 50 ml tubes spun at 10,000×g for 30 mins, followed by five more rounds of centrifugation where the material from the top and bottom layers is resuspended separately in fresh diluent in 1.8 ml tubes and spun at 20,000×g for 5 mins per round.

If delivery particles are observed microscopically in both the top and bottom layers, then the particles from these two layers are recombined after the final centrifugation step, to create a single sample containing all the delivery particles extracted from that product. The extracted particles should be analyzed as soon as possible but may be stored as a suspension in DI water for up to 14 days before they are analyzed.

One skilled in the art will recognize that various other protocols may be constructed for the extraction and isolation of delivery particles from finished products, and will recognize that such methods require validation via a comparison of the resulting measured values, as measured before and after the particles' addition to and extraction from finished product.

C. Dye and/or Fabric Hueing Agent

The relative amount of dye and/or fabric hueing agent can be approximated by determining the absorbance of a sample composition according to the method below. The greater the absorbance, the greater the concentration of dye and/or fabric hueing agent. To determine the absorbance of a sample, percentage transmittance is first determined according to the following method.

The percent transmittance is determined by measuring the percentage of light transmittance through samples using a UV-Vis Spectrophotometer operated in transmission mode, at 480 nm, using 1 cm path length cuvettes, in accordance with the following procedure. Suitable instruments include the Beckman Coulter model DU 800 UV-Vis Spectrophotometer (Beckman Coulter Inc., Brea, Calif., USA).

All sample preparations and analyses are conducted in a laboratory with air temperature of 22° C.+/−2° C.

Turn on the spectrophotometer lamps and allow them to warm up for 30 minutes prior to commencing measurements. Set the instrument to collect the measurement in Percentage Transmission (% T) mode, at a wavelength of 480 nm. Load all sample emulsions into 1 cm path length plastic cuvettes. If air bubbles are visible in the cuvettes, use a pipette to remove the bubbles, or let the bubbles settle out of the cuvette prior to measurement.

Zero the baseline of the spectrophotometer by using a cuvette loaded with deionized (DI) water. Measure the % T of the DI water sample (typically reported as a number between 1 and 100). The instrument should read 100% T; if it does not, then re-zero the instrument using the same cuvette of DI Water.

Measure the % T of the cleaning composition sample and record its value.

Absorbance is determined from the % T value according to the following equation:

Absorbance=2−log(% T)

D. Enzymes

The enzyme activity level is reported as a percentage relative to the initial activity level.

Prepare a diluent solution of 0.5 g calcium chloride dihydrate (Sigma-Aldrich, cat. # C-5080) and 10 g sodium thiosulfate pentahydrate (Sigma-Aldrich, cat. # S-6672) in 1 liter of deionized water (18.2 mega Ohms MΩ or better). Prepare a TRIS buffer of 12.1 g tris-hydroxymethyl-aminomethane (Sigma-Aldrich, cat.#-1503), 1.1 g of calcium chloride dihydrate and 5.0 g sodium thiosulfate pentahydrate, pH 8.3 in 1 liter of deionized water. Prepare a working PNA solution by diluting 250 uL of a 1 gram of N-Succinyl-ALA-ALA-PRO-PHE p-nitroanilide (“PNA”; Sigma-Aldrich, cat. # S-7388) per 10 mL dimethyl sulfoxide (J.T. Baker, cat. # JT9224-1) into 25 mL TRIS buffer.

1. Protease analysis. Protease analysis is carried out by reaction of a protease containing sample with Succinyl-Ala-Ala-Pro-Phe p-nitroanilide resulting in a change in absorbance over time spectrophotometrically. The response is proportional to the level of protease present in the sample. The protease sample is prepared by dilution in diluent solution. The reaction begins by incubation of 250 uL of working PNA solution at 37° C. for 360 seconds then delivery of 25 uL sample preparation and monitoring change in absorbance at 405 nm. The protease active level is determined by relation to a protease level vs. reaction rate calibration established for that specific protease. For example, a reference curve may be established by measuring post-reaction absorbance as described above over a range of known enzyme concentrations, for example, from about 1 mg enzyme/100 g product to about 100 mg enzyme/100 g product.

2. Amylase analysis. The amylase reaction uses a combination of the alpha amylase present in the sample and an alpha glucosidase to react with a modified p-nitrophenylmaltoheptaside containing a terminal glucose unit blocked with an ethylidene group. This terminal blocking inhibits cleavage by the alpha-glucosidase until the initial internal bonds can be cleaved by the alpha-amylase followed by alpha-glucosidase. The increase in absorbance (@ 405 nm) per minute, facilitated by the release of pNP by the alpha-glucosidase, is directly proportional to the alpha-amylase activity in the sample. The amylase sample is prepared by dilution in diluent solution. The reaction reagents are provided in Infinity amylase reagent (Thermo Electron, cat. # T-1503). The reaction begins by incubation of 190 uL of Infinity amylase reagent at 37° C. for 360 seconds then delivery of 50 uL of the diluted sample preparation and monitoring the change in absorbance at 405 nm spectrophotometrically. The amylase active level is determined by relation to an amylase level vs. reaction rate calibration established for that specific amylase. For example, a reference curve may be established by measuring post-reaction absorbance as described above over a range of known enzyme concentrations, for example, from about 1 mg enzyme/100 g product to about 100 mg enzyme/100 g product.

### III. Determination of Direct Adjunct Concentration of a Large Sample

To determine the Direct Adjunct Concentration of a Large Sample, the concentration of the selected adjunct in a given Large Sample is determined directly according to any suitable method known to one of ordinary skill, including those described above if appropriate. In such direct determinations, the Large Sample is not further subdivided into Small Samples, unless called for by the method of determining the adjunct concentration.

### IV. Determination of Calculated Adjunct Concentration of a Lame Sample

To determine the Calculated Adjunct Concentration of a Large Sample, the Large Sample is subdivided into a population of Small Samples as described above. The adjunct concentration for each Small Sample is determined according to a suitable method, known to one of ordinary skill, for the selected adjunct. The adjunct concentrations are then averaged (weight averaged, if the Small Samples are not of identical amount) to determine the Calculated Adjunct Concentration of the Large Sample from which the Small Samples were derived.

### V. Determination of Adjunct Variation Index (AVI)

From the adjunct concentrations of the Small Samples, an Adjunct Variation Index (AVI) for a product is determined according to the following calculations.

To note, a mean (X̅) is calculated according to the following equation, where N represents the number of samples being averaged:

X̅=Σ(Xᵢ)/N.

Using the mean, a relative standard deviation (RSD) is calculated according to the following equation:

RSD=100*[1/(N−1)*Σ(Xᵢ−X̅)²]^{0.5}/X̅.

Means and relative standard deviations are used to calculate an Adjunct Variation Index according to the following method.
1. For each given Large Sample, subdivide into Small Samples, determine the adjunct concentration in the given population of Small Samples, and determine a Calculated Adjunct Concentration of a Large Sample.
2. From the Calculated Adjunct Concentrations of the Large Samples, calculate the Relative Standard Deviation of the Large Samples (“RSD-L”).
3. For each population of Small Samples derived from a Large Sample, calculate the Relative Standard Deviation of the Small Samples (“RSD-S”) in that population.
4. From the Relative Standard Deviations of the Small Samples, calculate the Mean Relative Standard Deviation of the Small Samples (“MRSD-S”) (i.e., find the average of the RSD-S's obtained in step 3).
5. Determine an Adjunct Variation Index (AVI) for the packaged product by dividing the Mean Relative Standard Deviation of the Small Samples by the Relative Standard Deviation of the Large Samples (i.e., divide the number obtained in step 4 by the number obtained in step 2). See the following equation:

AVI=(MRSD-S)/(RSD-L)

It may be preferred for the AVI of a composition to be equal to or less than 1.0, or equal to or less than 0.75, or equal to or less than 0.6, or equal to or less than 0.5, or equal to or less than 0.4, or equal to or less than 0.3, or equal to or less than 0.25. The AVI of a composition of the present disclosure may be greater than or equal to 0.05, or greater than or equal 0.1, or greater than or equal 0.2.

### VI. Determination of Relative Concentration

The relative concentration of an adjunct in a particular region or dose population of a packaged product may be determined according to the following method.

The product is divided into Large Samples as described above. For each Large Sample, the Direct Adjunct Calculation or the Calculated Adjunct Concentration may be determined, as described above.

Once the concentration (Direct or Calculated) of the selected adjunct in each Large Sample is determined, the mean of the Large Samples (MEAN-L) and the relative standard deviation of the Large Samples (RSD-L) may be calculated.

Furthermore, once the concentration of the selected adjunct in each Large Sample is determined, the concentrations of different regions of the bottle may be determined, using the first 10% of the Large Samples as a proxy for the first samples or doses used by a consumer and the last 10% of the Large Samples as a proxy for the last samples or doses used by a consumer.

For example, if the packaged composition provides a total of 30 Large Samples (N=30), the first three (Large Samples 1, 2, and 3) and the last three (Large Samples 28, 29, and 30) are compared. If 10% of N is not a whole number, the next largest whole number of Large Samples is to be used. For example, if N=35 (where 10% of 35=3.5), 4 Large Samples for each fraction are to be compared.

The concentration of a given adjunct may be greater in the top of the container than in the bottom of the container, or greater in the first dose(s) used by a consumer compared to the last dose(s). The mean adjunct concentration of the first 10% of the Large Samples (MEAN-alpha) may be greater than the mean adjunct concentration of the last 10% of the Large Samples (MEAN-omega). MEAN-alpha may be at least 1%, or at least 2%, or at least 3%, or at least 5%, or at least 7.5%, or at least 10%, greater than MEAN-omega. It may be that the value of the expression [(MEAN-alpha*100/MEAN-L)−100] is equal to or greater than 0.25*RSD-L, or equal to or greater than 0.5*RSD-L, or equal to or greater than 0.75*RSD-L, or equal to or greater than 1.0*RSD-L. It may be that the value of the expression [(MEAN-omega*100/MEAN-L)−100] is equal to or greater than −0.25*RSD-L, or equal to or greater than −0.5*RSD-L, or equal to or greater than −0.75*RSD-L, or equal to or greater than −1.0*RSD-L.

The concentration of a given adjunct may be greater in the bottom of the container than in the top of the container, or greater in the last dose(s) used by a consumer compared to the first dose(s). The mean adjunct concentration of the last 10% of the Large Samples (MEAN-omega) may be greater than the mean adjunct concentration of the first 10% of the Large Samples (MEAN-alpha). MEAN-omega may be at least 1%, or at least 2%, or at least 3%, or at least 5%, or at least 7.5%, or at least 10%, greater than MEAN-alpha. It may be that the value of the expression [(MEAN-omega*100/MEAN-L)−100] is equal to or greater than 0.25*RSD-L, or equal to or greater than 0.5*RSD-L, or equal to or greater than 0.75*RSD-L, or equal to or greater than 1.0*RSD-L. It may be that the value of the expression [(MEAN-F*100/MEAN-L)−100] is equal to or greater than −0.25*RSD-L, or equal to or greater than −0.5*RSD-L, or equal to or greater than −0.75*RSD-L, or equal to or greater than −1.0*RSD-L.

VII. Determination of Change in RSD over Time

The change in RSD of an adjunct concentration can be measured over time to estimate the change in heterogeneity over time, e.g, during the course of storage. The change in RSD can be determined by the following method.

Two identical packaged products are provided. It is preferred that they are of similar age. For example, the packages may be provided as freshly off of the production line. Alternatively, they may be provided as two adjacent packages on a store shelf (where it is assumed that adjacent bottles were transported in the same secondary packaging, such as a crate or pallet, indicating that they were manufactured at approximately the same time). The products should be handled identically up to the time of analysis and/or storage, where it is attempted to minimize agitation of the package.

The first packaged product is divided into Large Samples as provided above, and the concentration of a selected adjunct in each Large Sample is determined according to either method provided in Sections III (Direct) or IV (Calculated) above. From this data, the relative standard deviation of the concentrations of the Large Samples is determined (RSD-new).

The second packaged product is stored, without agitation, for an aging period, e.g. two weeks, at room temperature (20° C.). After the storage period, the second packaged product is divided into Large Samples as provided above, and the concentration of the same selected adjunct in each Large Sample is determined according to same method employed in the previous paragraph. From this data, the relative standard deviation of the concentrations of the Large Samples is determined (RSD-aged).

From these calculations, the ratio of the RSD-aged to the RSD-new can be determined. It is preferred that the RSD-aged: RSD-new ratio is equal to or less than about 1, indicating that the relative homogeneity of the product remained the same or increased during the aging period (i.e., the product did not become more heterogeneous). A ratio above about 1 indicates that the relative homogeneity of the product decreased during the aging period, which can result in phase instabilities, such as phase separations. It may be preferred that the RSD-aged: RSD-new ratio is equal to or less than about 1, or equal to or less than about 0.9, or equal to or less than about 0.8, or equal to or less than about 0.75.

### VIII. Non-Homogeneity Relative to Analysis Method

As described above, the concentration of the given adjunct in a Large Sample is be determined by a suitable method. It is assumed that even when a homogeneous product is analyzed, every method for determining the concentration of a given adjunct will provide a range of results having a relative standard distribution. In fact, a given method may have a known/validated relative standard deviation (“RSD-method” or “RSD-M”) when applied to a well-mixed/homogeneous product. The RSD of a particular product may be compared to the RSD-M to estimate the relative non-homogeneity of the particular product.

The product to be tested (“tested product”) is divided into Large Samples as provided above, and the concentration of a selected adjunct in each Large Sample is determined according to either method provided in Section IV (Determination of Relative Concentration) above. From this data, the relative standard deviation of the concentrations of the Large Samples derived from the product (RSD-P) is determined.

If the RSD-M for a given method is not known, a packaged product that is identical to the tested product (“comparison product”) is provided. Mix the comparison product well, for example by inverting the package 50 times. The well-mixed comparison product is then divided into Large Samples as provided above, and the concentration of a selected adjunct in each Large Sample is determined according to either method provided in Section IV (Determination of Relative Concentration) above. From this data, the relative standard deviation of the concentrations of the Large Samples derived from the comparison product (RSD-method) is determined.

A ratio of the respective RSD's of the tested product and of a homogeneous product tested according to the given method can be determined. If the tested product is relatively non-homogeneous, it is expected that the ratio of RSD-P: RSD-method will be greater than 1. It may be preferred that the RSD-P: RSD-method ratio is at least about 1.1, or at least about 1.2, or at least about 1.3, or at least about 1.4, or at least about 1.5.

It may be preferred that the RSD-P: RSD-method ratio is at least about 1.1, and that the RSD-aged: RSD-new ratio is equal to or less than about 1. This may indicate that the product is substantially non-homogeneous at a given point in time, but that the product either stays the same or increases in homogeneity over time, indicating good product stability.

### EXAMPLES

The examples provided below are intended to be illustrative in nature and are not intended to be limiting.

### Example 1. Making a Perfumed Detergent Product

A 1.47 liter (50 fl. oz.) bottle of a perfumed liquid detergent product is made according to the following method.

The following components are added directly to a detergent bottle in the following proportions: 2.6 parts of a 1:1 mixture of neat perfume and propanediol; 1.5 parts of a dye premix (1% Liquitint Blue AH (available from Milliken & Co., South Carolina, USA), plus propanediol and water); 3 parts propanediol; 1 part water.

Then, a base detergent that is free of perfume and dye is added to the bottle at an average rate of 750 mL/second. Without wishing to be bound by theory, it is believed that the turbulence from the addition of at least the base detergent somewhat mixes the resulting liquid detergent composition. However, no additional intentional mixing or shaking is performed. Even so, the resulting liquid detergent composition visually appears as a single phase compositions.

### Example 2. Analyzing a Perfumed Detergent Product, Part 1

The single-phase perfumed liquid detergent product obtained in Example 1 is analyzed for perfume concentration differences.

First, the packaged detergent product is divided into 26 Large Samples according to the preparation method provided above. Each Large Sample is approximately 57 mL.

The perfume concentration of each Large Sample is directly determined (e.g., without subdividing into Small Samples) according to the Headspace Analysis Method provided above. As described above, the Headspace Analysis Method has a Relative Standard Deviation (RSD-method) of 4.6%.

The perfume concentration of each Large Sample is provided below in Table 1. From the directly measured perfume concentrations of the Large Samples, the average perfume concentration (avg), the standard deviation (std dev), and the relative standard deviation of the product (RSD-P) of the product are calculated and reported in Table 1.

TABLE 1

| | Perfume |
|---|---|
| Large | Concentration |
| Sample # | (wt %) |
| 1 | 1.416 |
| 2 | 1.543 |
| 3 | 1.466 |
| 4 | 1.235 |
| 5 | 1.275 |
| 6 | 1.470 |
| 7 | 1.399 |
| 8 | 1.243 |
| 9 | 1.269 |
| 10 | 1.529 |
| 11 | 1.406 |
| 12 | 1.354 |
| 13 | 1.315 |
| 14 | 1.389 |
| 15 | 1.257 |
| 16 | 1.119 |
| 17 | 1.133 |
| 18 | 1.262 |
| 19 | 1.355 |
| 20 | 1.354 |
| 21 | 1.085 |
| 22 | 1.336 |
| 23 | 1.387 |
| 24 | 1.293 |
| 25 | 1.231 |
| 26 | 1.352 |
| MEAN-S | 1.326 |
| Std. deviation | 0.116% |
| RSD-L | 8.764% |

The ratio of the relative standard deviation of the product to the relative standard deviation of the headspace analysis method (RSD-P/RSD-method=8.764%/5%=1.75) is greater than 1, indicating that the product is a non-homogeneous composition.

Furthermore, the average concentration of the first three Large Samples (average of 1, 2, and 3=1.475%) is greater than, and more than one standard deviation away from, the average concentration of the last three Large Samples (average of 24, 25, and 26=1.292%), indicating that the product is a non-homogeneous composition.

Additionally, the differences in average concentrations between the first three Large Samples and the last three Large Samples indicate that the concentration of perfume in the first several doses used by a consumer is greater than the concentration of perfume in the last several doses used by a consumer. One of ordinary skill will appreciate that a greater concentration of an adjunct such as perfume in a dose is likely to provide a greater benefit in use.

### Example 3. Analyzing a Perfumed Detergent Product, Part 2 (Simulation)

Using the data determined in Example 2, as shown in Table 1 above, a simulation was performed to further illustrate the calculations of the present disclosure. More specifically, for each Large Sample for which actual data was collected, a population of Small Samples, each having an identical simulated volume and a varying simulated perfume concentration, was simulated to create a Small Sample data set. The data set of perfume concentrations was simulated in a Monte Carlo fashion, using a random selection from a Gaussian probability distribution, where the data points, including the mean and RSD-M, from the Large Samples of Example 2 served as starting points/parameters for the simulation.

A portion of the simulated perfume concentrations are provided below in Table 2. Specifically, the population of Small Samples 1-30 are derived from the parameters obtained from Large Sample 1 (i.e., perfume concentration of 1.416 wt %).

TABLE 2

| | Simulated |
|---|---|
| Small | Perfume |
| Sample # | Conc. (wt %) |
| 1 | 1.404 |
| 2 | 1.449 |
| 3 | 1.382 |
| 4 | 1.369 |
| 5 | 1.417 |
| 6 | 1.379 |
| 7 | 1.455 |
| 8 | 1.317 |
| 9 | 1.435 |
| 10 | 1.252 |
| 11 | 1.346 |
| 12 | 1.410 |
| 13 | 1.490 |
| 14 | 1.388 |
| 15 | 1.375 |
| 16 | 1.484 |
| 17 | 1.382 |
| 18 | 1.377 |
| 19 | 1.471 |
| 20 | 1.411 |
| 21 | 1.520 |
| 22 | 1.381 |
| 23 | 1.400 |
| 24 | 1.438 |
| 25 | 1.485 |
| 26 | 1.416 |
| 27 | 1.416 |
| 28 | 1.416 |
| 29 | 1.381 |
| 30 | 1.438 |

In the given simulation, the weighted average concentration of the perfume in the population of Small Samples is 1.409%; in other words, the Calculated Adjunct Concentration of Large Sample 1 is 1.409%. (To note, the Direct and Calculated Adjunct Concentrations of a given Large Sample may be slightly different due to variations inherent in the test methods.) The standard deviation of the perfume concentration of the population of Small Samples is 0.0544, and the Relative Standard Deviation of the Small Samples (RSD-S) of this population is 3.863.

Similar simulations are conducted for 26 Large Samples based on Table 1. Based on the results of the simulated Small Samples for each Large Sample, Calculated Adjunct Concentrations for each Large Sample are determined according to the method provided above and are provided in Table 3 below. The standard deviation for each population of Small Samples (where each population is derived from a respective Large Sample), and the Relative Standard Deviations of the simulated Small Samples (RSD-S) are also provided in Table 3.

The calculated Relative Standard Deviation of the Large Samples (RSD-L) and the Mean Relative Standard Deviation of the Small Samples (MRSD-S) are also provided below.

TABLE 3

| | Calculated | | |
|---|---|---|---|
| | Adjunct Conc. | Std. Dev. Of | Relative Std. Dev. of |
| Large | of Large | Small | Small Samples |
| Sample # | Sample (wt %) | Samples | (RSD-S) |
| 1 | 1.409 | 0.0544 | 3.863 |
| 2 | 1.524 | 0.0914 | 5.997 |
| 3 | 1.464 | 0.0650 | 4.442 |
| 4 | 1.249 | 0.0599 | 4.791 |
| 5 | 1.267 | 0.0572 | 4.516 |
| 6 | 1.464 | 0.0784 | 5.354 |
| 7 | 1.394 | 0.0749 | 5.372 |
| 8 | 1.247 | 0.0577 | 4.624 |
| 9 | 1.270 | 0.0734 | 5.781 |
| 10 | 1.525 | 0.0765 | 5.020 |
| 11 | 1.388 | 0.0627 | 4.520 |
| 12 | 1.353 | 0.0749 | 5.534 |
| 13 | 1.308 | 0.0648 | 4.955 |
| 14 | 1.368 | 0.0727 | 5.313 |
| 15 | 1.260 | 0.0701 | 5.567 |
| 16 | 1.112 | 0.0451 | 4.056 |
| 17 | 1.146 | 0.0465 | 4.061 |
| 18 | 1.255 | 0.0592 | 4.715 |
| 19 | 1.362 | 0.0656 | 4.815 |
| 20 | 1.368 | 0.0674 | 4.929 |
| 21 | 1.073 | 0.0480 | 4.472 |
| 22 | 1.324 | 0.0787 | 5.944 |
| 23 | 1.389 | 0.0794 | 5.714 |
| 24 | 1.295 | 0.0575 | 4.443 |
| 25 | 1.242 | 0.0602 | 4.846 |
| 26 | 1.363 | 0.0748 | 5.487 |
| Mean | MEAN-L: | 0.0660 | Mean RSD-S |
| | 1.324 | | (MRSD-S): 4.967 |
| RSD-L | 8.575 | | |

From this simulated data, a simulated Adjunct Variation Index (AVI) for the product composition is calculated as follows.

AVI=MRSD-S/RSD-L=4.967/8.575

AVI=0.579

The calculated AVI of this simulation is below 1.0, meaning that the adjunct (perfume) is well-dispersed into small droplets or dissolved at the local level, but is not consistently distributed throughout the bottle as a whole.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A packaged, non-homogeneous liquid composition,
the composition residing in a container,
the composition being a single phase liquid composition,
the composition comprising water and an adjunct selected from encapsulates, neat perfume, enzymes, fabric hueing agents, conditioning agents, fabric enhancement polymers, pearlescent agents, opacifiers, or mixtures thereof,
wherein, when the composition is divided into Large Samples according to the method described herein (Preparation of Large Samples),
the first about 10% of the Large Samples comprise a first average adjunct concentration (Direct or Calculated) of the adjunct, and
the last about 10% of the Large Samples comprise a second average adjunct concentration (Direct or Calculated, determined the same manner as the first average adjunct concentration) of the adjunct,
wherein either:
a) the first average adjunct concentration is at least about 1% greater than the second average adjunct concentration; or
b) the first average adjunct concentration is at least about 1% less than the second average adjunct concentration.

2. The liquid composition according to claim 1, wherein the first average adjunct concentration is at least about 1% greater than the second average adjunct concentration.

3. The liquid composition according to claim 1, wherein the first average adjunct concentration is at least about 1% less than the second average adjunct concentration.

4. The liquid composition according to claim 1, wherein the first average adjunct concentration is not more than 25% greater or not more than 25% less than the second average adjunct concentration.

5. A liquid composition,
the liquid composition being disposed in a container,
the liquid composition being a single phase liquid composition,
the liquid composition comprising an adjunct ingredient,
wherein when the composition is divided into Large Samples according to the method provided herein, the weighted mean adjunct concentration of the first 10% of Large Samples is at least 1% different than the mean adjunct concentration of all of the Large Samples.

6. A liquid composition according to claim 5, wherein the weighted mean adjunct concentration of the first 10% of Large Samples is at least 1% greater than the mean adjunct concentration of all of the Large Samples.

7. A liquid composition according to claim 6, wherein the weighted mean adjunct concentration of the first 10% of Large Samples is at least 1% less than the mean adjunct concentration of all of the Large Samples.

8. A liquid composition,
the liquid composition being disposed in a container,
the liquid composition being a single phase liquid composition,
the liquid composition comprising an adjunct ingredient,
wherein the liquid composition is characterized by an Adjunct Variation Index, as determined according to the method provided herein, of equal to or less than 1.0.

9. The liquid composition of claim 1, wherein the adjunct is neat perfume, encapsulates, dye, a hueing agent, a conditioning agent, a fabric enhancement polymer, or a mixture thereof.

10. The liquid composition of claim 1, wherein the adjunct is neat perfume that comprises from about 2% to about 15%, by weight of the neat perfume, of Quadrant I perfume ingredients having a boiling point lower than 250° C. and a C log P lower than 3.

11. The liquid composition of claim 1, wherein the adjunct ingredient is enzymes.

12. The liquid composition of claim 1, wherein the adjunct ingredient is dye, a hueing agent, or a mixture thereof.

13. The liquid composition of claim 1, wherein the composition comprises from about 0.0001% to about 10%, by weight of the composition, of the adjunct ingredient.

14. The liquid composition of claim 1, wherein the composition further comprises a surfactant selected from the group consisting of anionic surfactants, nonionic surfactants, cationic surfactants, zwitterionic surfactants, amphoteric surfactants, ampholytic surfactants, and mixtures thereof.

15. The liquid composition of claim 1, wherein the composition further comprises a structurant.

16. The liquid composition of claim 1, wherein the Relative Standard Deviation of the Large Samples (RSD-L) is greater than the known or determined Relative Standard Deviation of the method used to determine the adjunct concentration (RSD-method).

17. The liquid composition of claim 1, wherein the liquid composition is characterized by an Adjunct Variation Index, as determined according to the method provided herein, of equal to or less than 1.0.

18. The liquid composition of claim 1, wherein the composition is a consumer product composition, preferably selected from the group consisting of fabric care compositions, hard surface cleaning compositions, dishwashing compositions, air care compositions, hair care compositions, and mixtures thereof.

19. The liquid composition of claim 1, wherein the liquid composition is characterized by a viscosity in the range of from about 200 to about 1000 mPa*s at 25° C. at a shear rate of 20 sec-¹.

20. The liquid composition of claim 1, wherein the container is a bottle comprising a handle.

21. The liquid composition of claim 1, wherein the composition is made by providing a base composition, and adding the adjunct ingredient to the base composition to form the non-homogeneous composition, preferably wherein the base composition is provided in the container.

22. A method of treating a surface, the method comprising the step of contacting a surface with the composition is according to claim 1.
